(19) United States
(12) Patent Application Publication
(10) Pub. No.: US 2010/0318558 A1
(43) Pub. Date: Dec. 16, 2010

(54) VISUAL METHOD AND SYSTEM FOR RDF CREATION, MANIPULATION, AGGREGATION, APPLICATION AND SEARCH

(75) Inventor: Christopher Craig Boothroyd, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: AFTERCAD SOFTWARE INC., Vancouver, BC (CA)

(21) Appl. No.: 12/518,060

(22) PCT Filed: Dec. 17, 2007
(86) PCT No.: PCT/CA2007/002282

§ 371 Date: Jul. 6, 2009

Related U.S. Application Data
(60) Provisional application No. 60/870,341, filed on Dec. 15, 2006.

(51) Int. Cl. G06F 17/30

(52) U.S. Cl. 707/769; 707/802; 707/E17.014

(57) ABSTRACT

The present invention provides a system and method whereby unsophisticated users can create manipulate and use semantic ontologies for storing, searching and retrieving information over the Internet by forming RDF statements using visual identifiers for predicates.

### CROSS REFERENCE TO RELATED APPLICATION

The present application claims the benefits, under 35 U.S.C. §119(e), of U.S. Provisional Application Ser. No. 60/870,341 filed Dec. 15, 2006 which is incorporated herein by this reference.

### TECHNICAL FIELD

The invention relates to methods and systems for storing, managing and accessing information, particularly over computer networks such as the World Wide Web.

### BACKGROUND

Previously, information retrieval on the Internet meant the use of search engines to locate web sites likely to contain the information of interest. If a user wishes to locate information about a subject, the user enters keywords into a search engine such as GOOGLE™, which retrieves the Universal Resource Locators (URLs) for web sites most likely to contain relevant information. The information located in that way is static in that the searcher can only view it and cannot modify the information located. Currently, the World Wide Web (“the Web”) is based primarily on documents written in HyperText Markup Language (HTML), a markup convention that is used for coding a body of text combined with multimedia objects such as images. HTML has limited ability to add meaning to the blocks of text on a page of a document, such as by adding metadata linked to the text, apart from including information on how the document is organized and its visual layout. There has therefore been a need for a more intelligent way to organize and look for information on the Internet.

Attempts to add intelligence in the form of computer-processable meaning to information on the Web have been referred to as development of a “Semantic Web”. Such attempts generally involve establishing systems of formally defined concepts called “ontologies”. Semantics and Ontologies have been in development for some time and there are many tools available to construct, edit and otherwise manipulate Semantic and Ontological data to create knowledge spaces and semantic inference. However to create an ontology requires understanding of complex ontology authoring tools such as Resource Description Framework (RDF) and Web Ontology Language (OWL). The tools and methodologies to engage Semantics in day to day usage are usable by only a very small number of specialized professionals and leave the vast majority of everyday computer/device users unable to participate and interact with semantic data. What is needed therefore is a methodology for the average person to interact with Semantically organized Information in such as fashion that they would not require technical knowledge of Ontologies, or other technical Semantic topics.

### SUMMARY OF INVENTION

The present invention provides a methodology for the average person to interact with semantically organized information in way that does not require technical knowledge of such as ontologies, RDF, OWL or other technical semantic topics, by using simple visual “semantic icons” to bridge the gap between a person's own knowledge base and the semantic ontologies developed for the computer to work with digital semantic knowledge. This technology is referred to herein as Visual RDF.

### BRIEF DESCRIPTION OF DRAWINGS

In drawings which disclose a preferred embodiment of the invention:

FIG. 1 is an example of a prior art RDF graph model;

FIG. 2 is a graph illustrating how the method of the invention displays the RDF graph model shown in FIG. 1;

FIG. 3 illustrates the Visual RDF statement in FIG. 2 written in Visual RDF notation;

FIG. 4 illustrates an example of a Visual Identifier in the form of an icon;

FIG. 5 shows a statement written in Visual RDF notation;

FIG. 6 illustrates a Visual RDF Predicate Tag;

FIG. 7 is a schematic diagram illustrating the steps in creation of Visual RDF;

FIG. 8 is a schematic diagram illustrating how users can share Visual RDF;

FIG. 9 is a schematic diagram illustrating how Visual RDF can be used to translate contextual meaning between users;

FIG. 10 is a schematic diagram illustrating Visual RDF Context Clustering;

FIG. 11 is a schematic diagram illustrating Visual RDF Semantic Content Management;

FIG. 12 is a schematic diagram illustrating searching using Visual RDF;

FIG. 13 is a schematic diagram illustrating a Visual RDF Semantic Object Property and Ranking System;

FIG. 14 is a diagram illustrating a number of visual identifiers; and

FIGS. 15-47 illustrate by means of screen shots a software application for creation of an Object/Predicate Icon Library, associating Icons to Ontology Terms, creating a Visual RDF Graph and forming Visual RDF queries.

### DESCRIPTION

Throughout the following description, specific details are set forth in order to provide a more thorough understanding of the invention. However, the invention may be practised without these particulars. In other instances, well known elements have not been shown or described in detail to avoid unnecessarily obscuring the invention. Accordingly, the specification and drawings are to be regarded in an illustrative, rather than a restrictive, sense.

The Resource Description Framework (RDF) is a language for representing information about resources in the World Wide Web, such as web pages, in a way that can be processed by computer. By providing a common framework for expressing this information, the information can be exchanged between different applications without loss of meaning, and application designers can take advantage of common RDF parsers and processing tools.

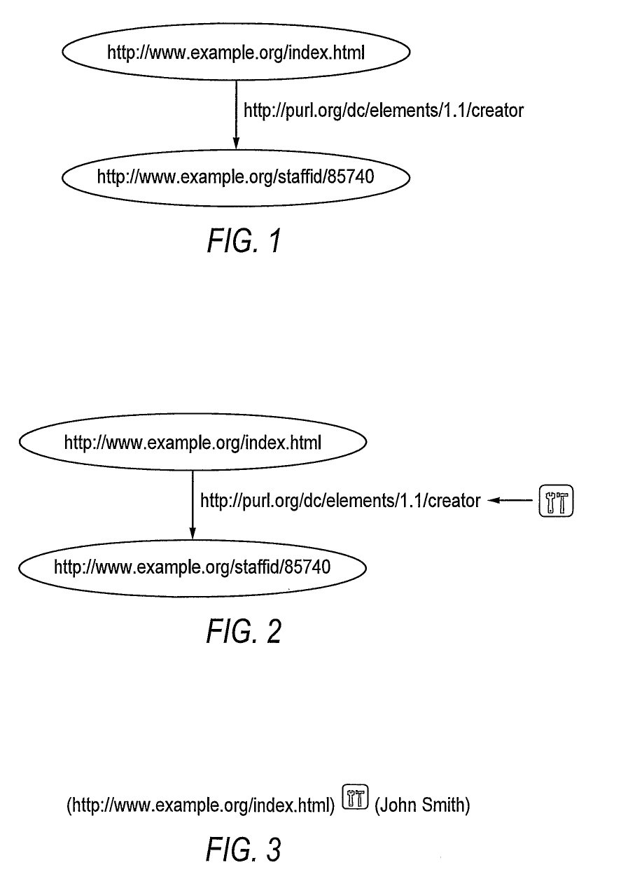

RDF is particularly intended to provide a common framework for representing metadata about Web resources, for example, copyright information about a Web page. It can also be used to represent information about things that can be identified on the Web, such as prices for products sold on-line, by generalizing the concept of a “Web resource”. RDF describes web resources using simple statements, each statement consisting of a subject, a predicate, and an object. Each statement is a triple, called a graph, consisting of subject, a predicate, and an object. Each triple or statement can be represented as a graph of nodes and arcs, a node representing the subject, a node representing the object and an arc for the predicate which is directed from the subject node to the object node. An example of an RDF graph model is shown in FIG. 1.

To identify subjects, predicates and objects in a machine-processable way, RDF uses Uniform Resource Identifiers (URIs). A URI can be created to refer to anything that needs to be referred to in a statement, including network-accessible things, such as electronic documents, or things that are not network-accessible, such as humans, or abstract concepts. RDF in fact uses URI references (URIref). A URIref is a URI, together with an optional fragment identifier at the end. For example, the URI reference
“http://vvww.example.org/index.html#section2”
   consists of the URI “http://www.example.org/index.html” and the fragment identifier “Section2”, separated by the “#” character. RDF uses the Extensible Markup Language [XML], in particular a specific XML markup language referred to as RDF/XML, to represent RDF statements in a machine-processable way.

Although RDF is an advance in the creation of the Semantic Web, RDF is intended for situations in which information needs to be processed by applications, rather than being displayed to people. Because of this, RDF is not intuitive to the common user who is not skilled in XML interpretation and manipulation.

Another method for adding meaning to web pages is Microformats. Microformats are markup that allow expression of semantics in an HTML (or XHTML) web page. Using microformats within HTML code provides additional formatting and semantic data that can be used by programs to extract meaning from a standard web page. Like RDF, Microformats are a step towards a Semantic Web but are not intuitive to the common user who is not skilled in HTML interpretation and manipulation.

Another method for adding meaning to web pages is tagging. Tagging involves associating a keyword or term with an item of information, such as an image, text article, video file etc. in order to permit keyword-based classification of such item. Tags are generally chosen informally and not as part of a formally defined classification system. However using tags in such a flexible fashion has drawbacks. Typically there is no information about the meaning or semantics of a tag. This lack of semantic distinction in tags can lead to inappropriate connections between items. Additionally, selection of “tag terms” is highly individualistic. Different people may use drastically different terms to describe the same concept. This makes the consumption of one tag set by another problematic at best and impossible between language or cultural divides. It also represents a significant amount of database search overhead compared to the subject/object specificity provided by a semantic approach.

The present invention provides a method for exacting semantic assignment in which the common user has the ability to directly create, assign, personalize and share the semantic object classifications in a more natural fashion such as the microformats and folksonomies approaches. Referred to herein as “Visual RDF”, it uses visual identifiers that are coupled with the predicate part of an RDF Statement. Much as RDF models statements as nodes and arcs in a graph, Visual RDF models statements about things as a graph model. In Visual RDF notation, a statement is represented by a node for the subject, a node for the object, an arc for the predicate, directed from the subject node to the object node, with a link to a visual object that represents the predicate. The Visual RDF statement version of the RDF graph model shown in FIG. 1 above would be represented by the graph shown in FIG. 2. The Visual RDF statement in FIG. 2 can also be written in Visual RDF notation as shown in FIG. 3.

According to the present invention visual identifiers are combined with an RDF statement to build ontological classifications of an object which gives the user visual context assignment and visual context recognition. This method provides a convenient visual way to manipulate object ontologies and other semantically organized data without having to know how to read and interpret semantically organized data directly.

The creation of Visual RDF sets by a user is accomplished by two main iterative steps, each with steps involving user interaction. These steps allow the user to assign context to the Visual RDF sets which can then be used to assign the Visual RDF context between a subject and an object, thus adding to the ontological relationships of the subject and object. The steps are 1) Creation of the Predicate Tag (visual identifiers+predicates); and 2) Creation of the Visual RDF Statement (Subjects+Predicate Tags+Objects).

### Visual Identifiers

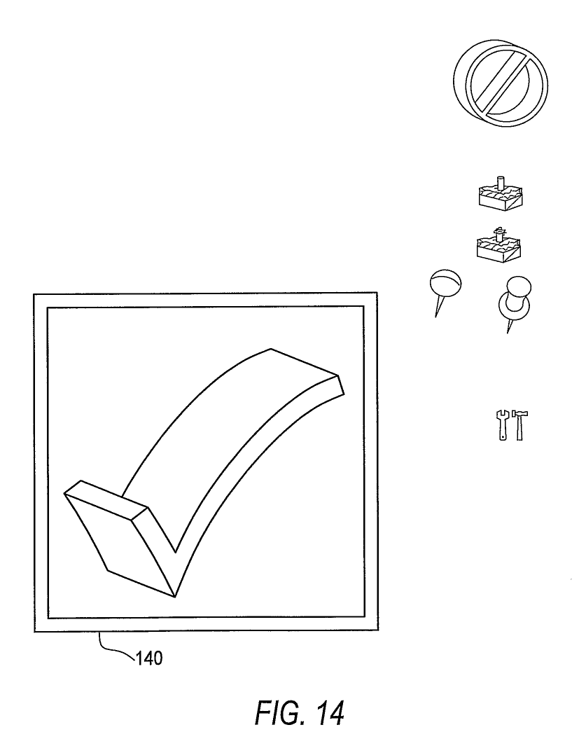

Visual Identifiers are pictographic representations of ontological information used as visual icons that are coupled to semantically defined information. The Visual Identifier acts as a “short cut” or visual bookmark for specific RDF semantic information. The Visual Identifier may be directly associated with a specific RDF Statement or may employ a specific “coupling” or “connection” to an ontology to add further meaning to the assignment of that particular visual identifier to that particular part of the ontology. Visual Identifiers can be organized into a library or collection of visually distinct objects. They comprise any visual element, whether simple or complex, two or even three dimensional, such as icons, animated icons, symbols, links, a picture, animation, video, word(s) or other media that can be used to visually identify the predicate. Typically the user will select the simplest form of visual identifier, an icon or symbol as it is small in size and visually compact. Examples are shown in FIG. 14. The more visually compact the chosen media is, the better it can be represented on mobile devices. The Visual Identifier collection can be private to the user, shared with a group and/or stored in a centralized location.

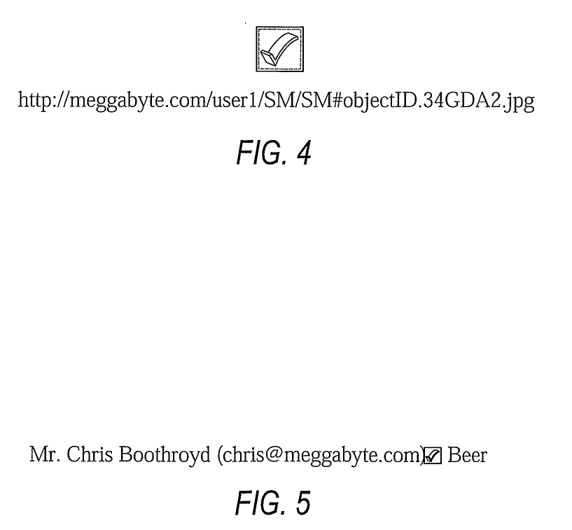

Visual Identifiers can display “state” such as giving them a blue border 140 to show search capability or a red border to show an alert or the availability of a data item such as an alert or message event. Visual Identifiers can be given or assigned a state by the user, thus adding to the context. Visual Identifiers can be displayed individually or in groups to convey context. Visual Identifiers can also represent a folder to be used as “hot folders” or “Draggable collection points” for other information. One Visual Identifier icon, for example, can be dragged onto another to change its meaning, or establish a semantic relationship, such as one icon being a thesauric stem or ontological root of the other. For example, the icons for “jog” and “lift” could be dragged onto the icon for “exercise” to set the latter as an ontological root for the former. Visual Identifiers can be coupled to an Ontological Root or to any item or group of items in an ontology. FIG. 4 illustrates an example of a Visual Identifier in the form of an icon, which is a JPEG image file stored in a user image collection in a database.

### Creation of the Visual RDF Predicate Tag

Predicates, as defined in RDF, typically are semantic predicates, natural language predicate statements and business process predicates. Predicates in RDF are used to establish the contextual relationship between a subject and object for the purpose of building a semantic relationship. The Predicate definition in RDF can be private to the user, shared with a group and/or stored in a centralized location. Examples are: RDF: “dc:creator”<dc:creator/>; Natural language: “likes” <likes/>; Business Process: “send to group list” <sendtogrouplist/>.

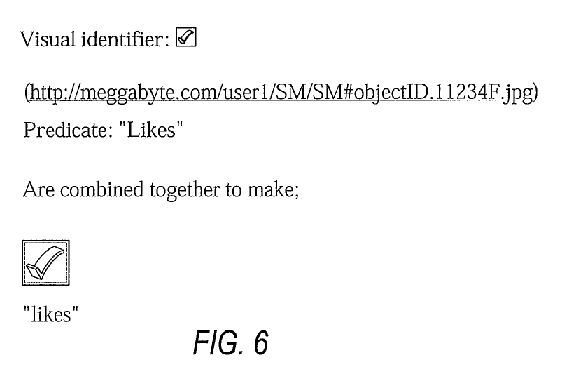

Visual RDF Predicate Tags: The Predicate Tag is a template RDF statement where the user has assigned a visual identifier to a predicate. These Predicate Tag objects typically take the form of RDF statements with the subject and objects left blank. The Predicate Tags can be private to the user, shared with a group and/or stored in a centralized location. A Visual RDF Predicate Tag is composed of two parts, a visual identifier and a predicate. An example is shown in FIG. 6. The Predicate Tag then is <likes rdf:resource=“http://meggabyte.com/user1/SM/SM#objectI D.11234F.jpg”/>.

### Creation of the Visual RDF Statement

Semantic Subjects and Objects: Subjects and Objects are “things” in a semantic sense and will be used with predicate tags to create Visual RDF statements. The subjects and objects are typically defined in a File system, Content Management System or database but can also be any accessible resource for valid RDF. For example, Chris (Subject) could be defined as: vrdf.contact:Person rdfabout=“http://meggabyte.com/visualrdfcoreNRDF#Chri s”>Beer (Object) could be defined as: vrdf.liquorontology:Beer rdf:about=“http://meggabyte.com/visualrdfcoreNRDF#Beer ontology.xml”>

Visual RDF Creation: Visual RDF is the collection of user defined RDF statements each with its own assigned visual identifier. The created Visual RDF Statements can be private to the user, shared with a group and/or stored in a centralized location. For example:

```
<?xml version=“1.0”?>
<rdf:RDF xmlns:rdf=“http://www.w3.org/1999/02/22-rdf-syntax-ns#”
            xmlns:visualrdf=“http://meggabyte.com/
            visualrdfcore/VRDF#”>
  <vrdf.contact:Person
rdf:about=“http://freedom.orbytsoft.com/visualrdfcore/VRDF#Chris”>
    <vrdf.contact:fullName>Chris Boothroyd</vrdf.contact:fullName>
    <vrdf.contact:mailbox rdf:resource=“mailto:chris@
    meggabyte.com”/>
    <vrdf.contact:personalTitle>Mr.</vrdf.contact:personalTitle>
<vrdf.contact:userpredicatelib.likes
rdf:resource=”http://meggabyte.com/user1/SM/SM#objectID.
11234F.jpg”/>
      Beer </vrdf.contact:userpredicatelib.likes >
  </vrdf.contact:Person>
</rdf:RDF>
```

Written in Visual RDF Notation, the above statement is shown in FIG. 5.

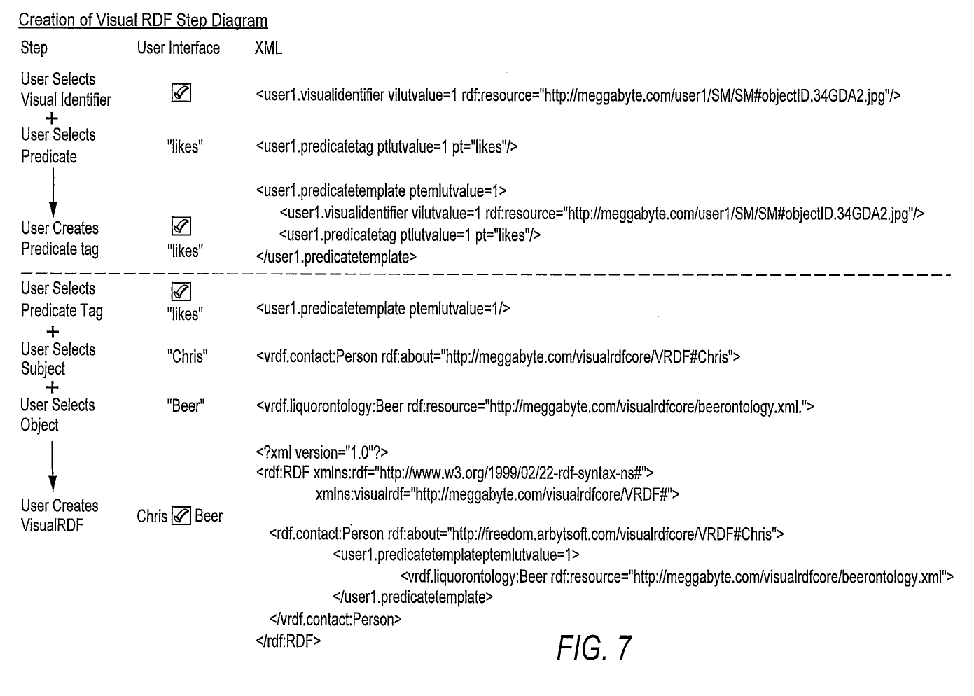

Novel Stepwise Visual Creation of RDF: The invention provides the stepwise association of a visual identifier with the Predicate, Subject and Object, as shown in FIG. 7 Creation of Visual RDF Step Diagram. Using this methodology, the user does not have to interpret or program any code, but rather uses a graphic user interface to visually create an RDF statement in a repeatable stepwise fashion. The Visual result can be instantly interpreted by the user or a variety of users who share the same or similar predicate understanding and the system can interpret the semantic exactness of the underlying RDF statement. as shown in FIG. 7, the user first selects a visual identifier from the user interface, such as by using mouse or keyboard commands such as double-clicking or clicking and dragging on an icon. This creates an XML statement, an example of which is shown in FIG. 7, which identifies, for example, a .jpg file containing the icon as the user's Visual Identifier. The user then selects a predicate from the user interface, in the form of text which can be selected from a menu or typed by the user, thereby creating an XML statement which identifies the predicate. The user then creates the Predicate Tag by associating the chosen Visual Identifier with the chosen predicate in the user interface, using mouse or keyboard commands, and thereby automatically generating the corresponding XML command. The Predicate Tag can then be saved in a folder or the like.

Next, as shown in FIG. 7, the user creates the Visual RDF Statement by i) selecting the saved Predicate Tag on the user interface, ii) selecting a subject from the user interface, in the form of text which can be selected from a menu or typed by the user, thereby creating an XML statement which identifies the subject, iii) selecting an object from the user interface, in the form of text which can be selected from a menu or typed by the user, thereby creating an XML statement which identifies the object, and iv) associating the chosen Predicate Tag with the chosen subject and object in the user interface, using mouse or keyboard commands, and thereby automatically generating the corresponding XML command. The Visual RDF Statement can then be saved in the user's ontology folder, database or the like, to form ontologies or triple stores, either on the client side or server side.

Using this approach achieves even what cannot be accomplished using RDF, Microformats or Tags, alone or in combination. It provides the flexibility of a user-definable predicate tagging system. It provides a functioning machine-readable semantic statement. It provides the precision of an unambiguous object definition. It is accessible by anyone due to Common user manipulation. The Visual RDF statements are shareable, to permit collaboration.

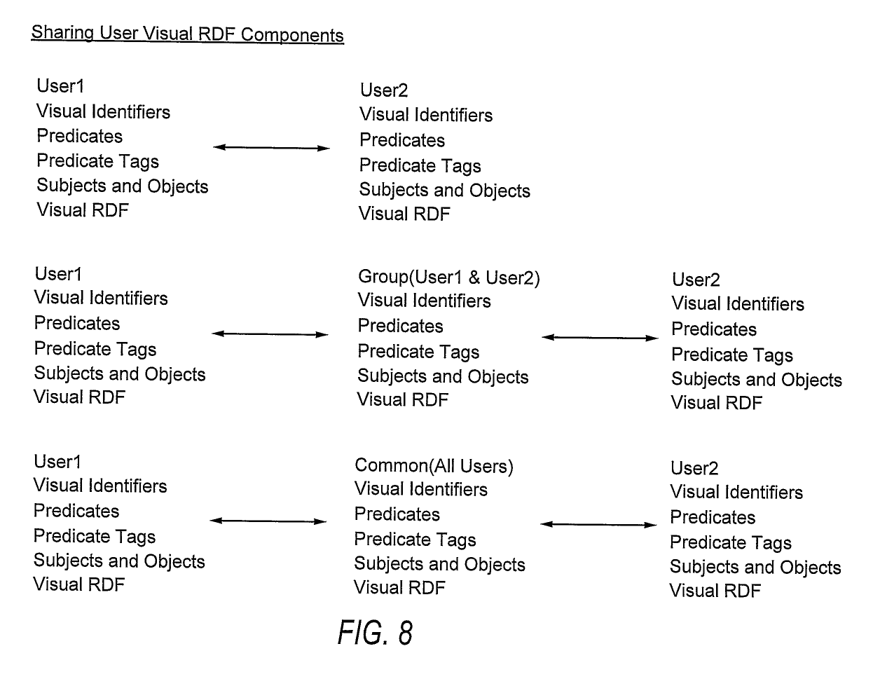

FIG. 8 illustrates how users can share Visual RDF. Users can share visual identifiers, predicates, predicate tags, subjects, objects and Visual RDF Statements between them directly or through a centralized database repository. The shared database of visual identifiers, predicates, predicate tags, subjects, objects and Visual RDF Statements can be shared among a limited group of two or more users, or can be made common to all users of the system.

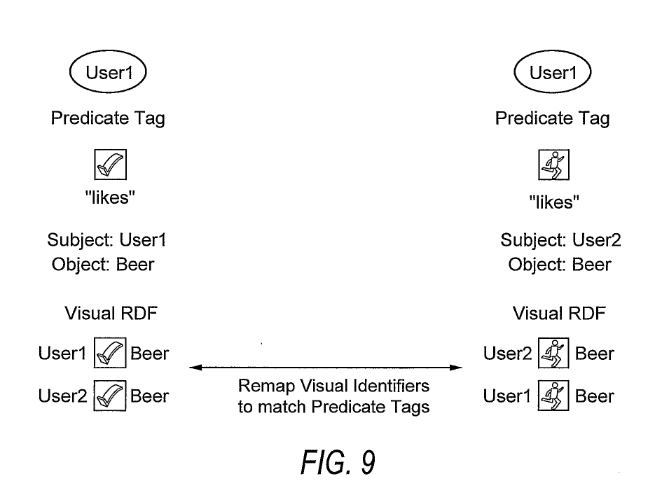

FIG. 9 illustrates how Visual RDF can be used to translate contextual meaning between users. Even though different users can have different visual identifiers associated with different predicate tags, the system can still present those to any user in a meaningful fashion. Using Visual RDF methods, the system can remap the visual identifier associated with another users' same/similar predicate tag to match the current users predicate tag for that predicate. By comparing one user's collection of predicates to determine matching or sufficiently similar predicates in a second users collection, the visual identifiers of the two users can be mapped onto each other. The degree of similarity can be set as very close or farther away based on thesauric, lexical or ontological standards. In this way a Visual RDF satement from one user can be mapped onto an equivalent Visual RDF statement of a second user.

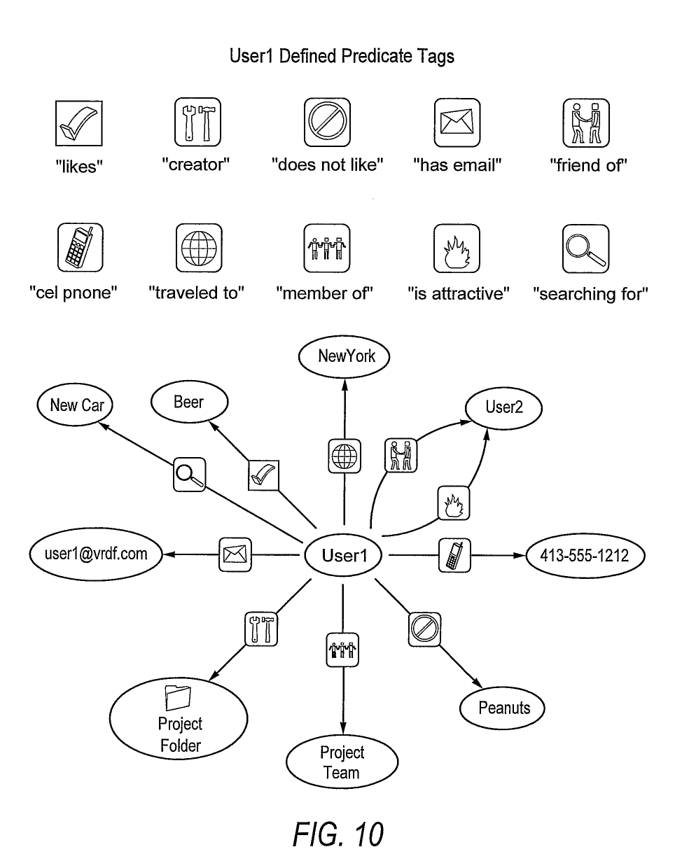

FIG. 10 illustrates an application of the Visual RDF statements, namely Visual RDF Context Clustering. Using the Visual RDF methods, the user can establish Visual RDF relationships between themselves and other things in the world. What the user is actually doing is building an RDF-based ontology based around Visual RDF context clusters as illustrated in FIG. 10. Having defined a number of Predicate Tags, User1 then creates a number of Visual RDF satements with User1 as the subject, thereby establishing Visual RDF relationships between the user and other things in the world. A similar cluster can also be formed using any other thing as the subject.

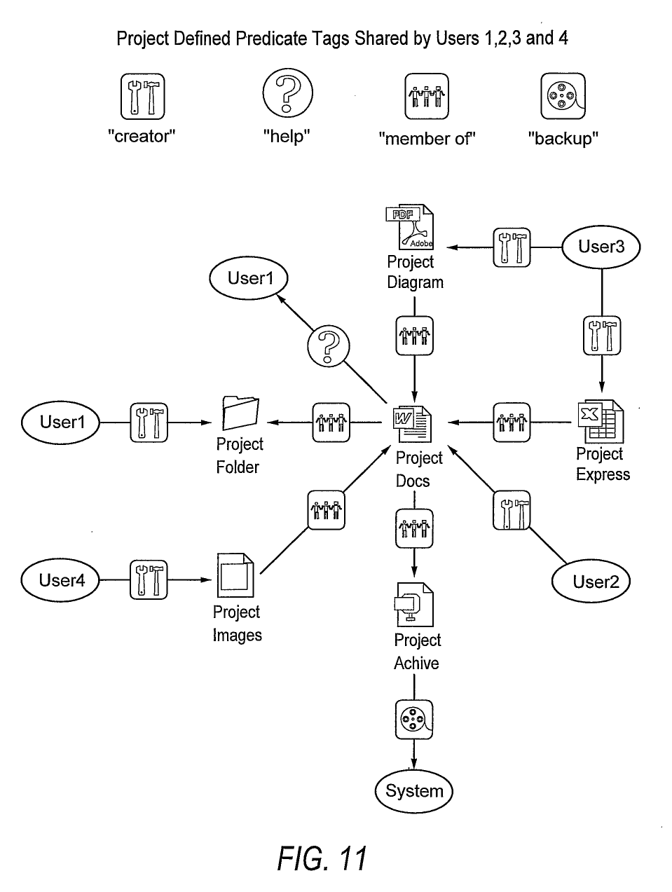

FIG. 11 illustrates an application of the Visual RDF statements for Visual RDF Semantic Content Management. In this example, four users, User1, User2, User3 and User4 are collaborating on a project and each user is able to use the Visual RDF method to define relationships between themselves and objects and between objects thus enabling for the first time, visual semantic content management and collaboration. Four Predicate Tags, as illustrated, have been defined for the group of users in the project, forming a shared library of Predicate Tags. Any one or more of the users can then create Visual RDF statements with users and things involved in the project, such as project documents, diagrams, images, folders, expenses and an archive as subjects and objects.

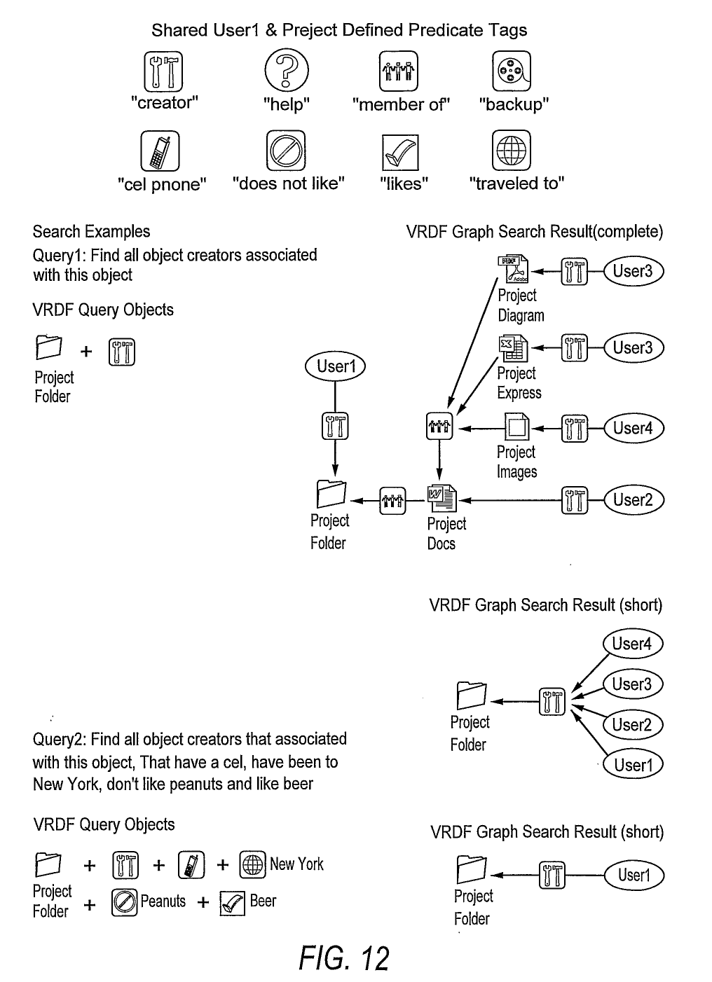

FIG. 12 illustrates searching using Visual RDF. With Visual RDF based searches, users build Visual RDF queries the same way the Visual RDF statements are built, by allowing the user to graphically manipulate icons. Search queries can be formulated using SPARQL Query Language as described in W3C Working Draft October 2006, or other suitable query language. SPARQL uses RDF to search other RDF statements collections (RDF Graphs) and Visual RDF can be used in place of RDF in the same way. Visual RDF can also be used to form a SPARQL Query to search RDF graphs or to display a SPARQL search result.

As shown in FIG. 12, Query1 uses the Project Folder (object) in conjunction with the creator predicate tag to create an RDF query (such as SPARQL). This can be accomplished by dragging the creator predicate tag onto the Project Folder object in a search context (as opposed to build RDF context). The search as shown is conducted on the graph shown in FIG. 11. The search can return the full Visual RDF graph result as shown or, at the users request, an abbreviated (“short”) Visual RDF graph search result. Query2 uses the Project Folder (object) in conjunction with the shown predicate tags and objects to increase the specificity of the Visual RDF graph search result as shown. Thus, unlike searches on relational databases where adding additional keywords increased th number of “hits”, adding additional search terms in the Visual RDF search quickly focusses the search. The search query can also specify the degree of separation of an object. The user can also utilize an interface where they could invoke OWL style rules to inject other arguments into the search parameters. For example: Query2+OWL[everyone who doesn't hate beer]

Visual RDF may be used to sort, filter or process other Visual RDF content. As with a relational database search, the searches themselves can act as filters or business rule processors and categorize clusters of RDF information that the user finds useful:
i) Create a list of Users who don't like peanuts;
ii) Create a list of Users who are designated helpers;
iii) Create a list of Users who are looking for a new car and process them through a car matching algorithm based on whether or not they like beer or peanuts.

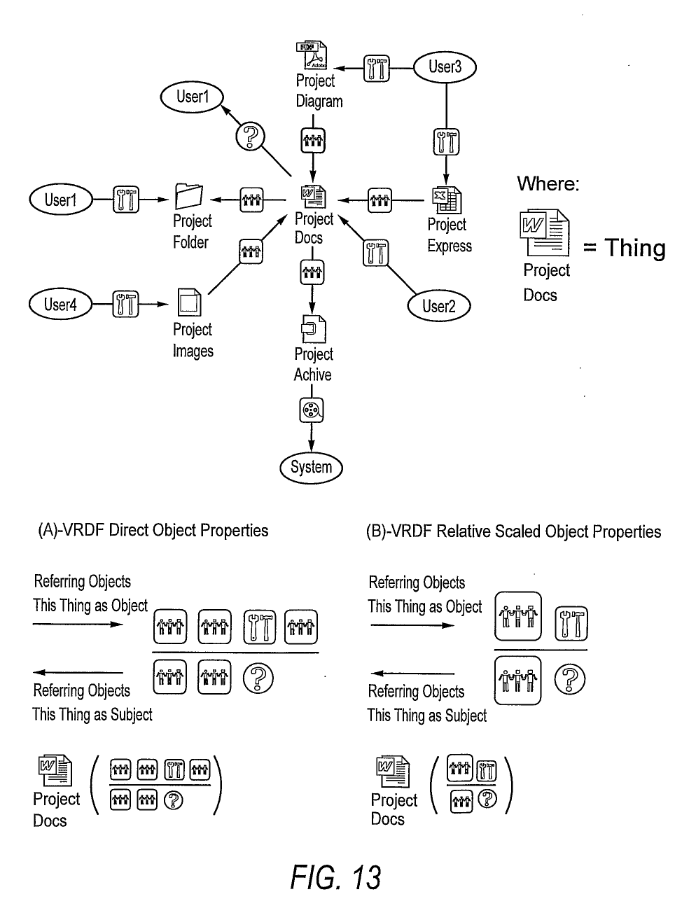

FIG. 13 illustrates a Visual RDF Semantic Object Property & Ranking System. Where it is not practical to constantly view Visual RDF graphs of context clusters such as the project diagram shown in FIGS. 11 and 13, it is possible to use a different diagrammatic method to convey an object's semantic properties, ranked for visual consumption. In the example shown in FIG. 13, instead of presenting the entire or partial context cluster around the Projects Docs object (referred to as the “Thing”), one can summarize the referring and referred Visual RDF statements and present it as in (A) or (B). In example (A), all of the Visual RDF referring statements that ‘point at’ the Project Docs object have been itemized in a clockwise fashion. One can put this over the sum of all of the Visual RDF statements that start at the Project Docs object and ‘point at’ other objects. In this fashion, a direct summary of Project Docs semantic properties has been created.

In example (B) one can ‘multiply’ same or similar Visual RDF predicate tags together to create a graphical ‘Ranking’ system that simplifies the summary view and display the relative number and type of referring/referred Visual RDF statements. In the case of a Web Page with a Visual RDF Object Rank, the user can click on one of the Ranking predicate tags and get a complete list of links that are referring to that page within the context of the chosen Predicate Tag (i.e. This web page is a member of these other pages.). In this fashion, a Visual RDF Page Ranking system similar to Google's page rank system is created, but semantically.

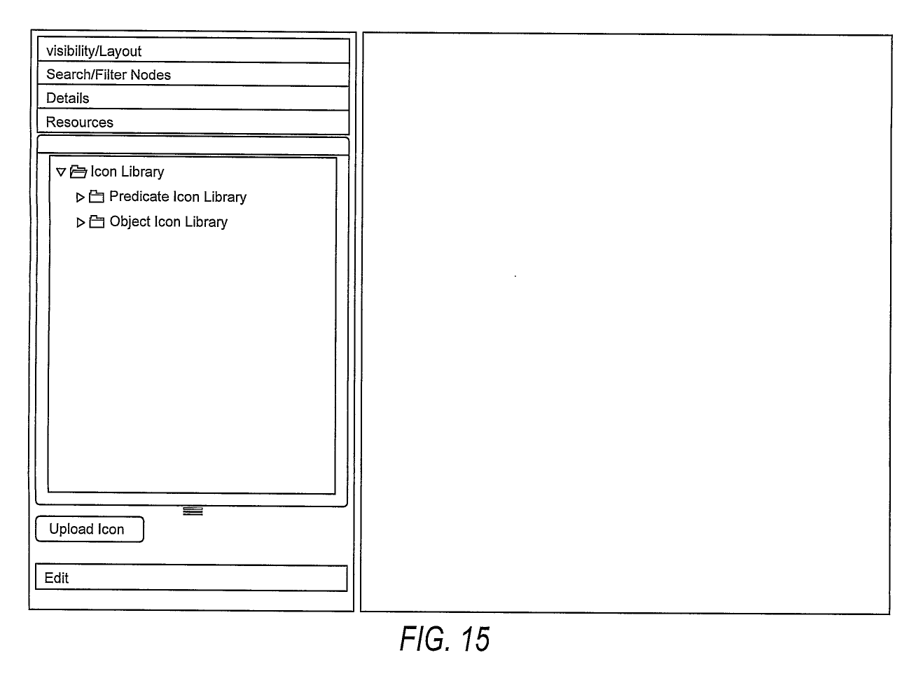

Thus the Visual RDF method allows one to:
a) Create—allow visual context assignment of ontological classification and create a Semantic Interface;
b) Read—Allow visual contextual identification “ontology at a glance” such as the ranking in FIG. 13;
c) Combine—Allow the visual interface to manipulate and combine ontologies or members of ontologies to build further contextual meaning “context/concept clustering” Graphs;
d) Search—Allow visual contextual searching methodology by using semantic icons (or combinations thereof) to create semantic queries “search clusters”;
e) Sort—allow sorting and grouping of semantic icons into further “context/concept clusters” and assign a unique semantic icon to that sorted cluster —“semantic consolidation”;
f) Filter—Allow the use of one set of semantic icons to filter through ontological data and produce other sets of semantic icons;
g) Process—allow a set of semantic icons to act as a semantic rule set to logically control a process using contextual information;
h) Translate—allow the Semantic icons to act as a translation bridge between different languages and users thus acting to map and translate subject context/concept;
i) Semantic Manipulation for Common Users;
j) Simplification of complex information for presentation on small footprint devices (mobile);
k) The usage of a desktop/portal model to populate and prepare the data to be accessed from a mobile device;
l) The preparation and accumulation of Context/Topic maps to be shared with other users.
   FIGS. 15-47 illustrate by means of screen shots a software application for creation of an Object/Predicate Icon Library, associating Icons to Ontology Terms, creating a Visual RDF Graph and forming Visual RDF queries.

### Creation of Object/Predicate Icon Library

Referring to FIG. 15, a screen shot of the application program illustrates starting the Visual RDF application with an empty library and empty graph.

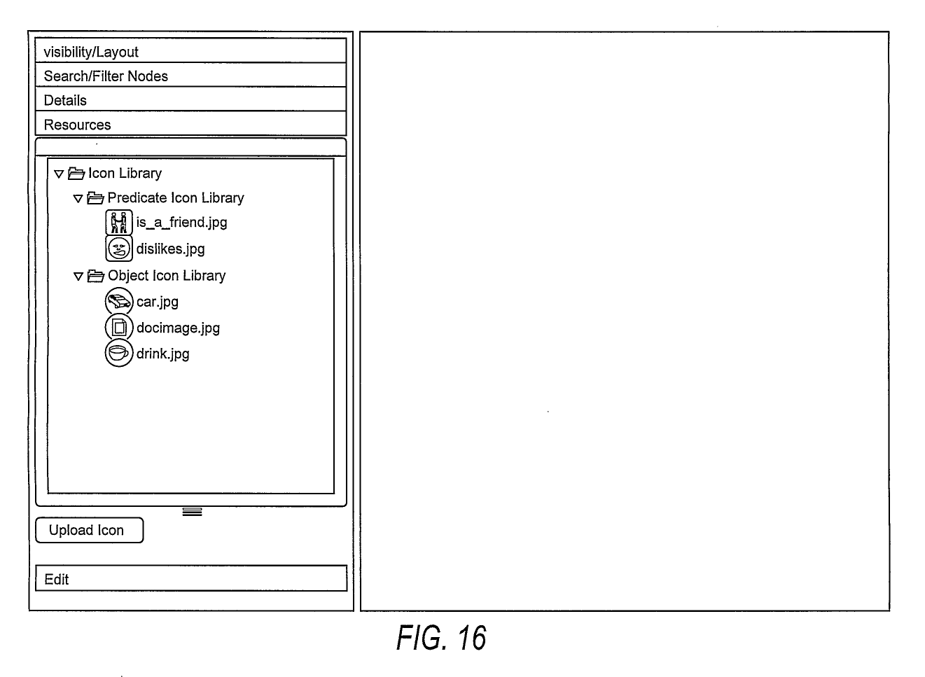

Referring to FIG. 16, from the Icon Library, the user clicks the Upload Icon button to upload his custom set of Predicate and Object Icons into Icon Library. At this point, these are just images, and not associated with any ontology.

### Associate Icons to Ontology Terms

Once the icons are ready, the user can go to the Edit panel to customize the Ontology Library. For the purposes of this example, the invention uses the Friend of a Friend (FOAF) ontology which is preloaded into the Visual RDF application. Refer to the Condensed FOAF Ontology in Table 1 for an abridged version of the official FOAF ontology. The user can import as many ontologies as he wants.

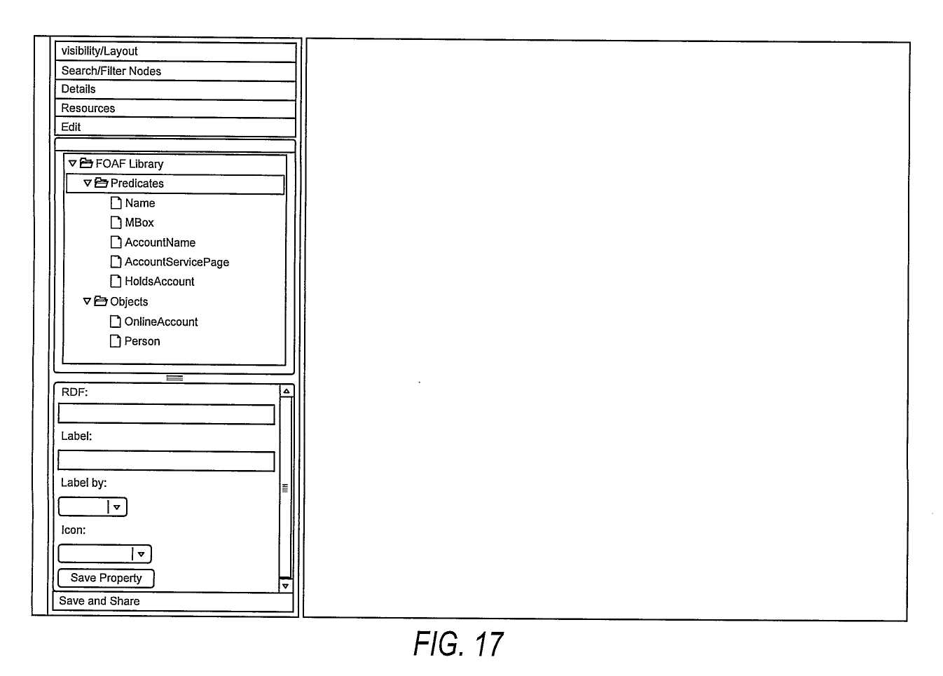

The ontology contains all the terms split between Objects and Predicates, as illustrated in FIG. 17.

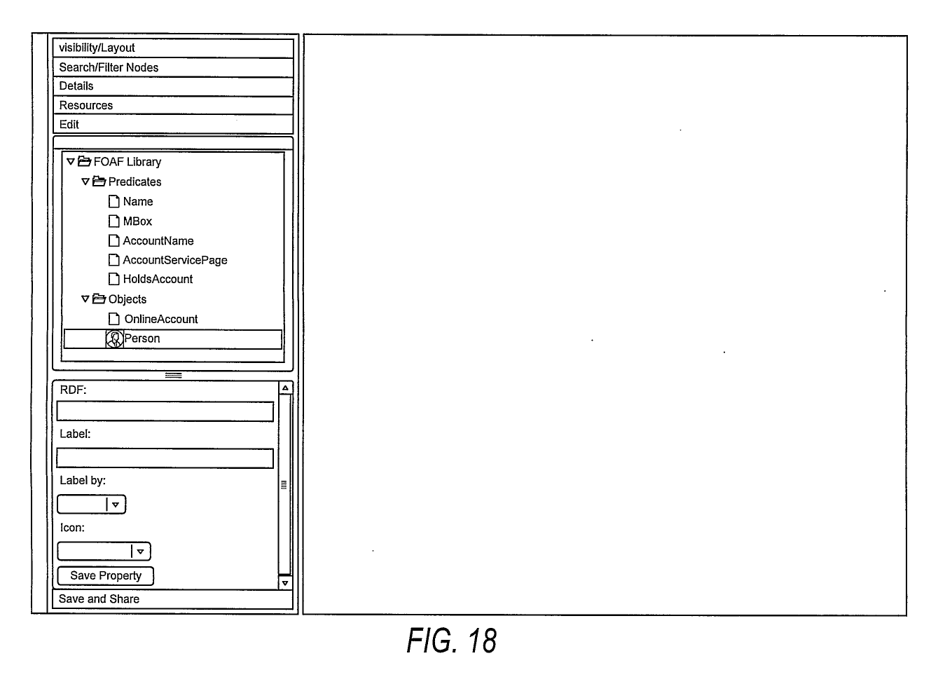

Referring to FIG. 18, the user selects a term from the FOAF library to customize its Visual Properties. In FIG. 18, “Person” is selected from Objects list. The Visual Properties for the selected term are displayed:

a. The RDF field displays the RDF term selected and cannot be modified. In this example, one is looking at the properties of the “Person” object in the FOAF ontology. This is displayed in shorthand as “foaf:Person” (refer to Definition 1 in Condensed FOAF Ontology).

b. The Label field defaults to the RDF label (in this case, “Person”), but it can be modified by the user. When a new “Person” object is placed onto the graph area, it will labeled with the contents of the Label field.

c. The Label By field is an optional field. The user can set this to any of the properties of the Person object. For example, personal mailbox and name are both properties of Person (refer to Definitions 2 and 3 in Condensed FOAF Ontology). In this example, one sets this to Name. See Creating a Visual RDF Graph, section 7 for an example where this is applied to a Visual RDF graph.

d. The Icon field is used to set the visual identifier for Person objects. The user can choose from among any icon in his Icon Library.

### Creating a Visual RDF Graph

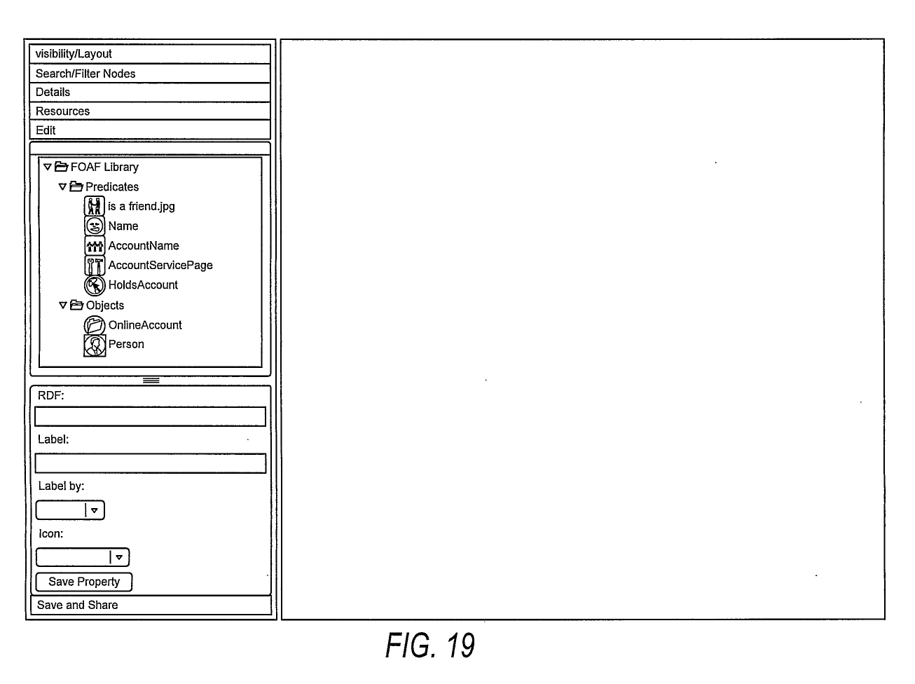

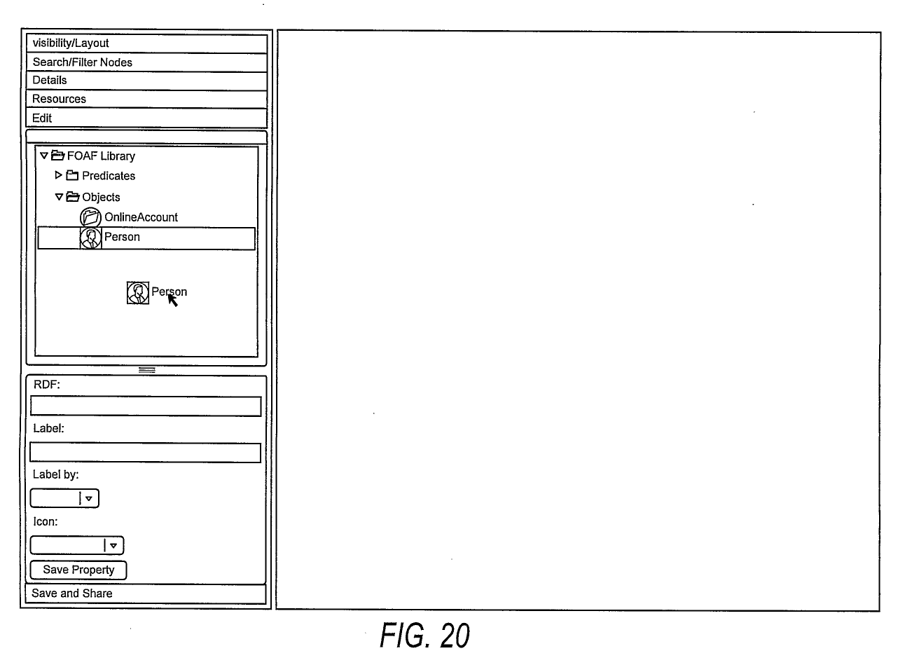

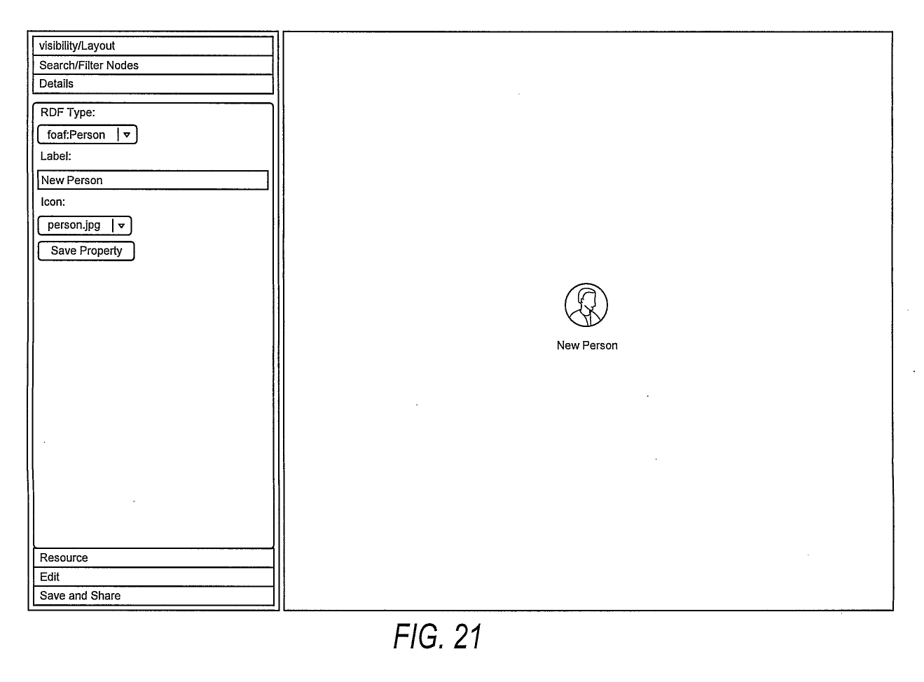

Referring to FIG. 19, after the visual properties are assigned to ontology terms in the ontology, the user can start to create a Visual RDF graph. In this case, one wants to create a new instance of a Person on the graph area. The Person is dragged from the library into the graph area to the right to create a new instance of a Person. See FIGS. 20 and 21. The new instance of Person is displayed in the graphing area. It will use the icon defined for Person objects as defined in the section Associate Icons to Ontology Terms above. It will also have the default label as defined in Associate Icons to Ontology Terms above, but prepended with the text “New” to signify to the user that this is a brand new instance. The default icon and label are shown also in the Detail Panel. From the Detail Panel, the user can modify the icon and label of this instance of Person. For example, the label can be changed to John, in order to, in this instance of a Person, describe the person John.

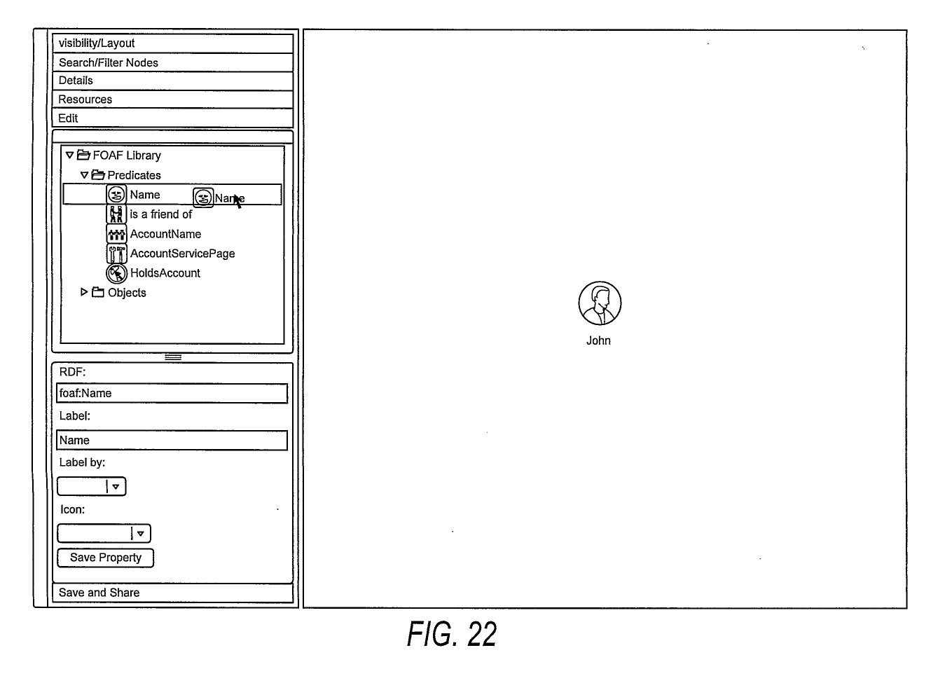

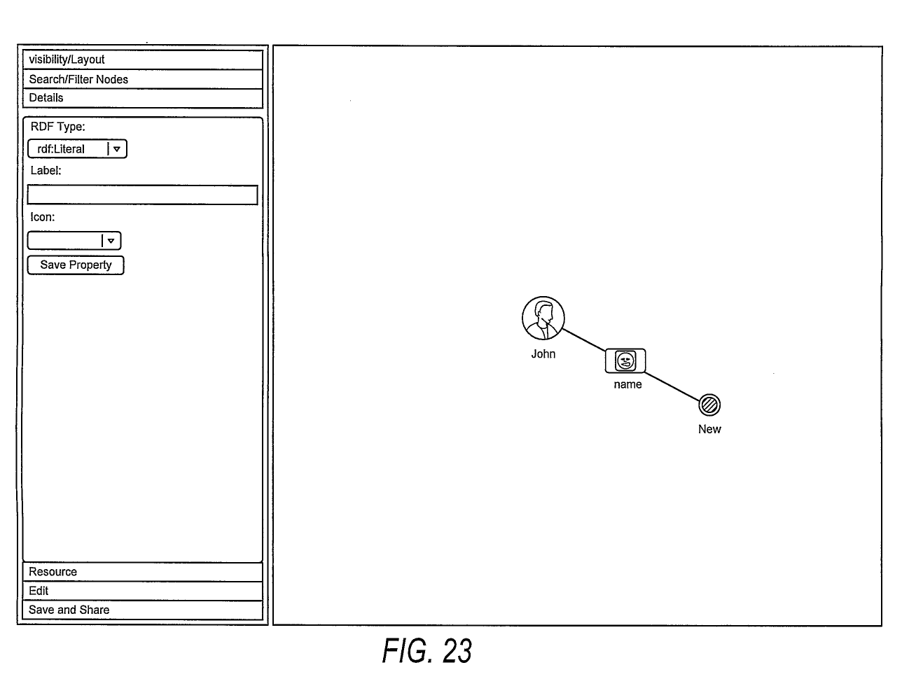

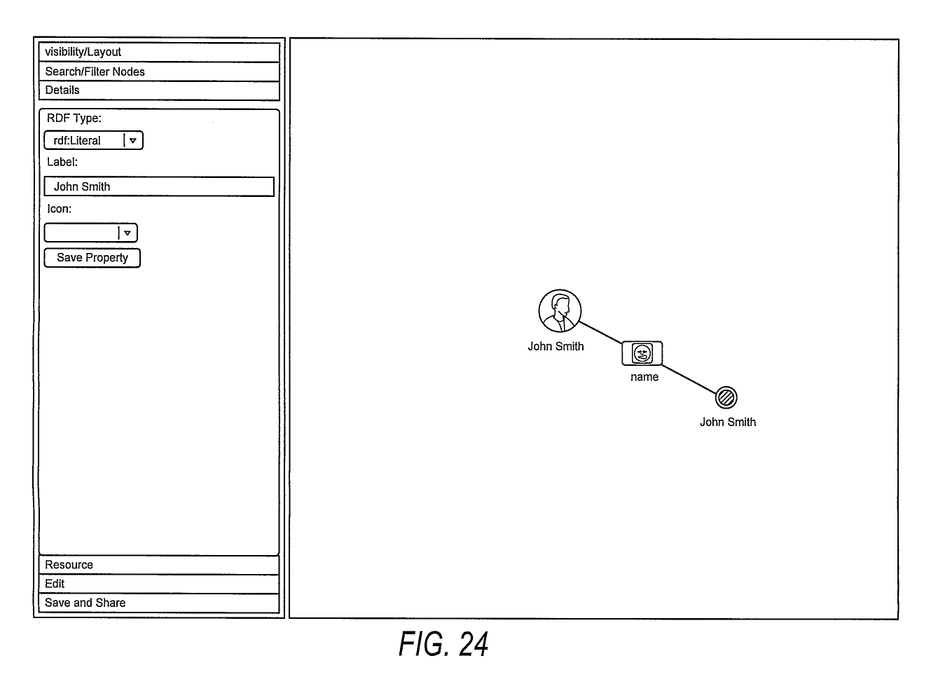

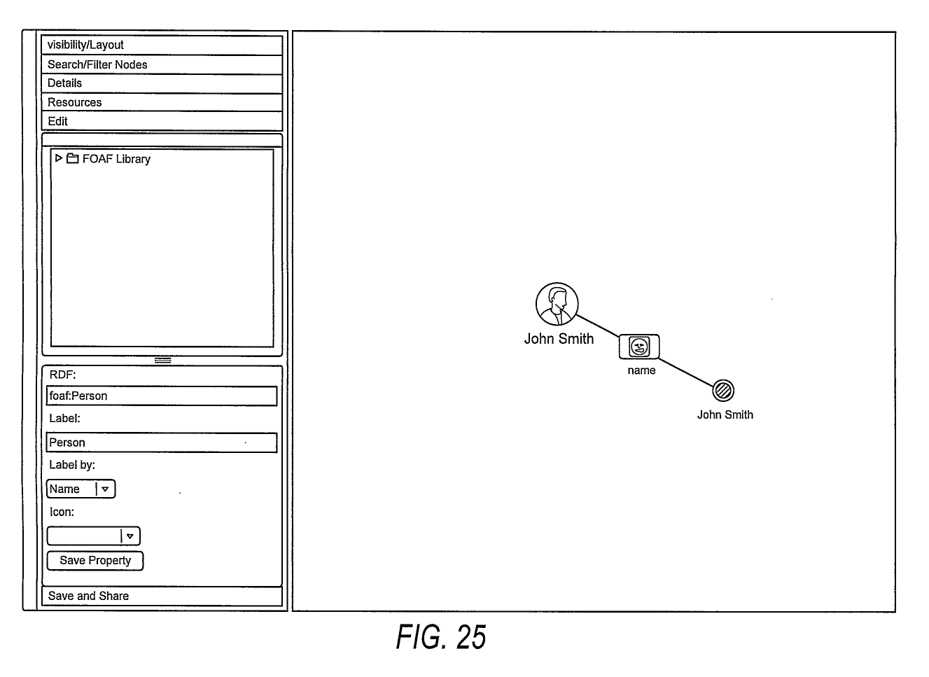

Referring to FIG. 22, a Visual RDF statement is now added to the graph with John as the subject. First, the user clicks on John, then selects the Name predicate and drag it onto the graph area. The Visual RDF application is intelligent enough to determine that the object of this Name predicate is a literal string and adds a new literal string object to the graph. See FIG. 23, 24. In FIG. 24 the label of this literal string is changed to “John Smith”. The Person labeled “John” has changed to “John Smith”. This behavior comes from setting Label By Name for Persons (refer to Associate Icons to Ontology, paragraph [0052]c. above). This informs the Visual RDF application to automatically assign the name literal to the visual label for the subject as shown in FIG. 25.

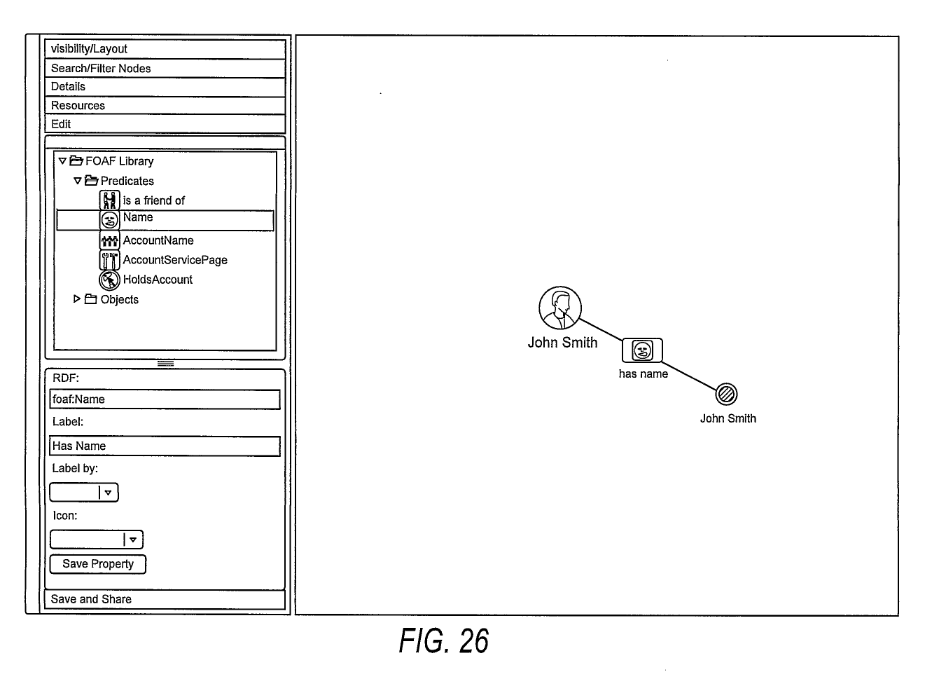

Referring to FIG. 26, if it is decided that the predicate label “name” is not descriptive enough, one can select the Name predicate from the FOAF library, and change the label from “name” into “has name”. All Name predicates in the graph will now be labeled as “has name”.

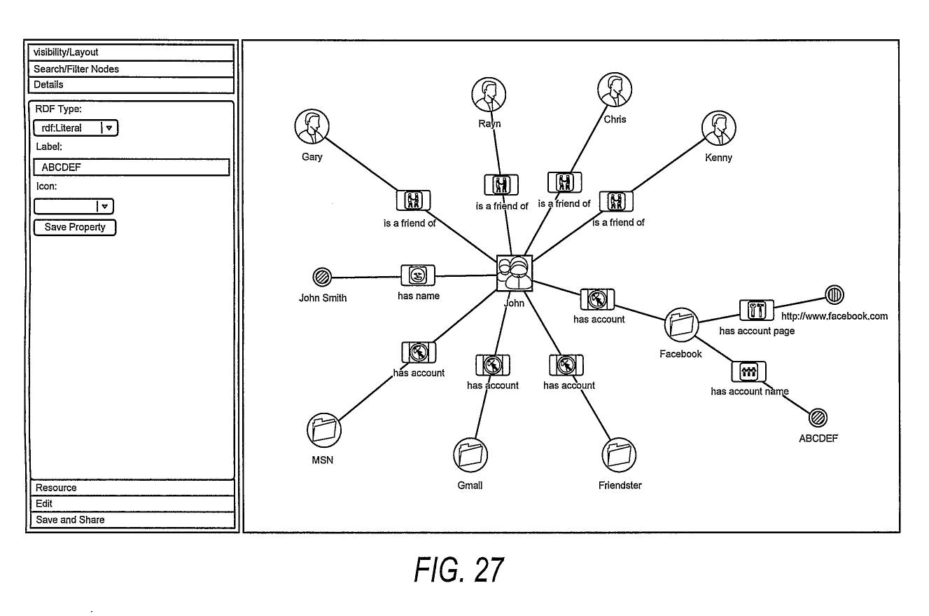

After some linking together of more Visual RDF statements, one may produce a graph as shown in FIG. 27. See Exported FOAF RDF in Table 1 for an example of what this graph would look like in a XML-formatted RDF file.

### Graph Layout

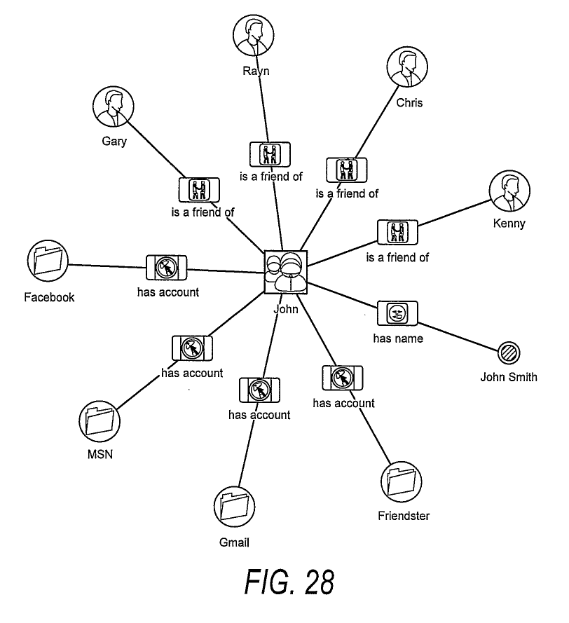

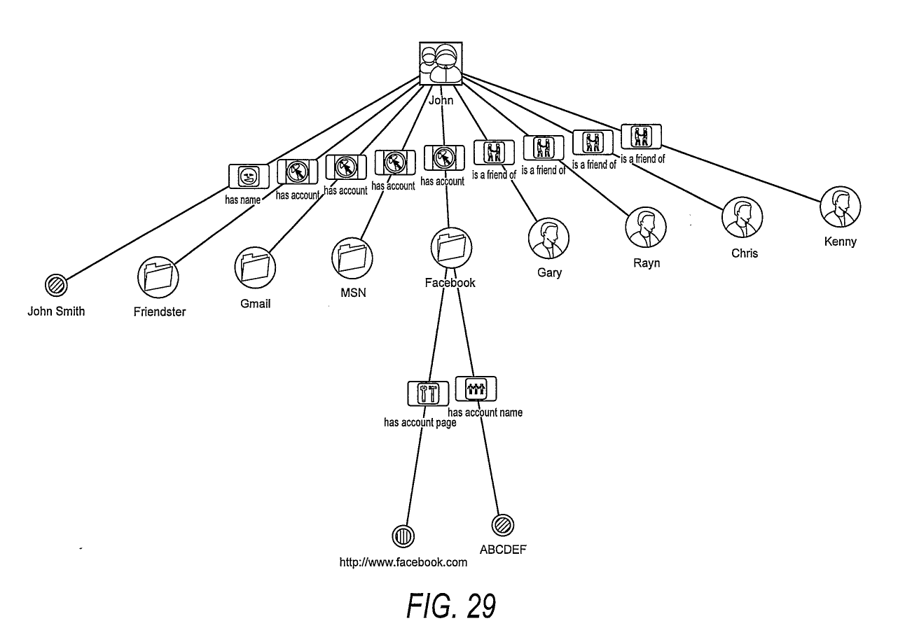

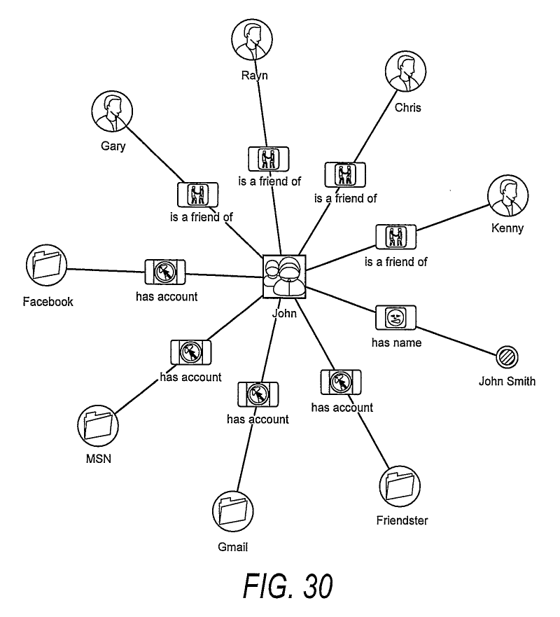

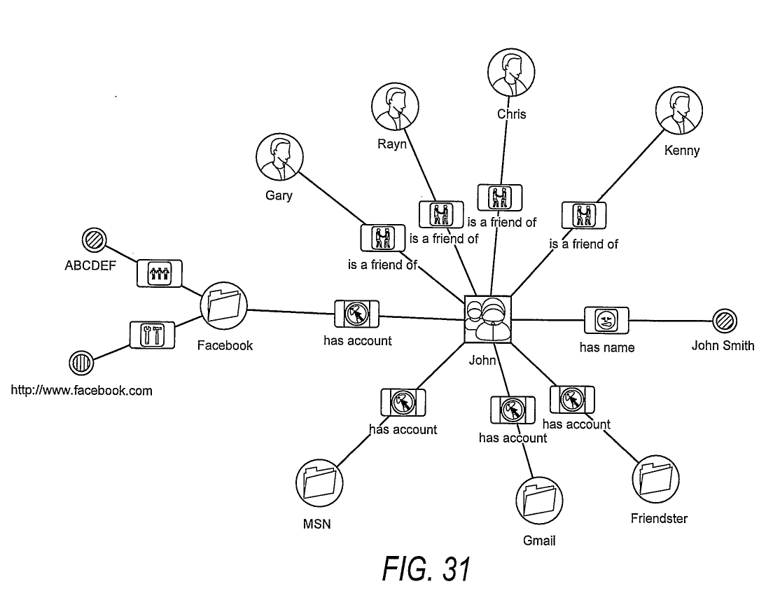

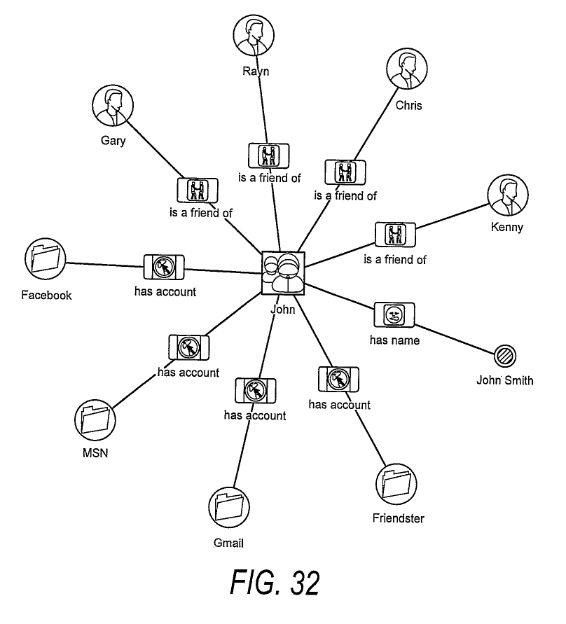

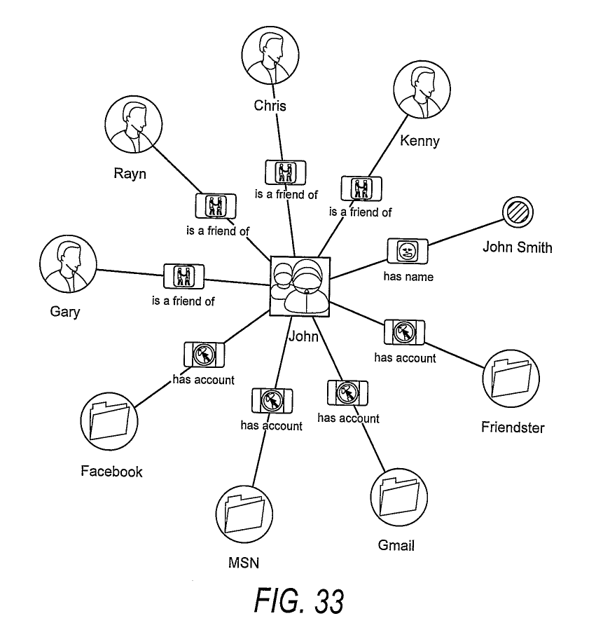

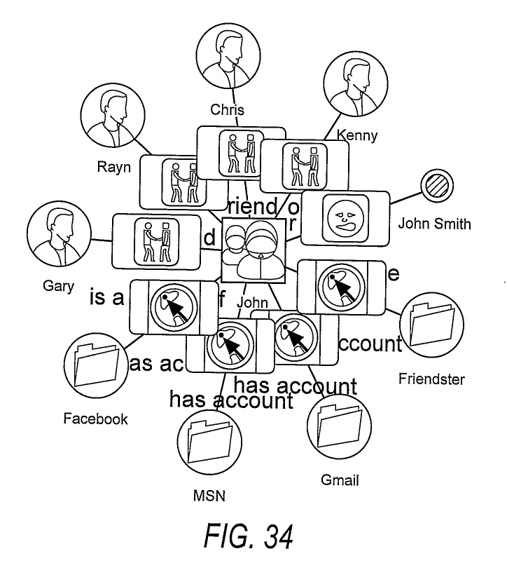

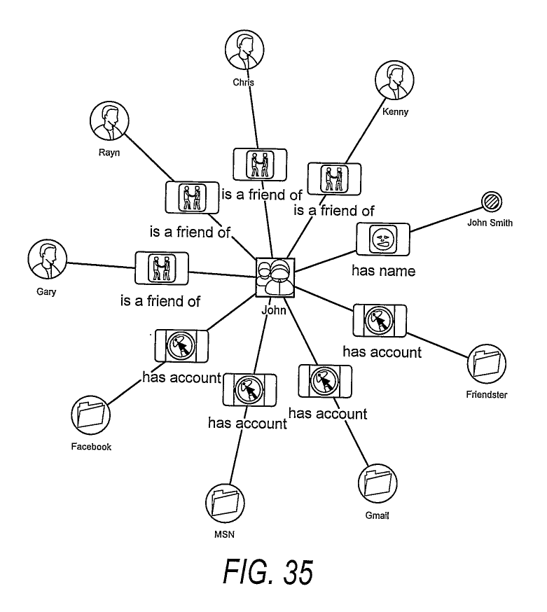

The Visibility/Layout Panel permits the setting of different graph layouts, such as Concentric Radial as shown in FIG. 28, or Hierarchical as shown in FIG. 29. The Visibility/Layout Panel permits the setting of Degrees of Separation. For the convenience of viewing the graph, one may want to limit the depth of nodes branching from the primary node to 1 Degree as shown in FIG. 30, or 2 Degrees, as shown in FIG. 31. One can scaling the size of visual identifiers (Zoom in/out), such as 1:1 scale (as shown in FIG. 32) or 1:1.4 scale (as shown in FIG. 33). One can adjust lengths of all edges together by the link length slide bar to “tighten up” or “loosen up” the graph, such as Length=100 as shown in FIG. 34 or Length=200 as shown in FIG. 35.

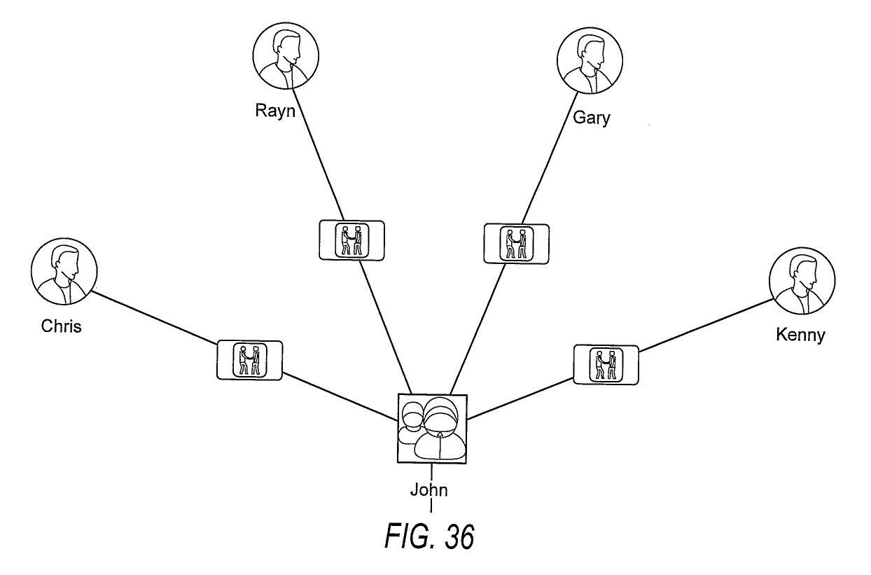

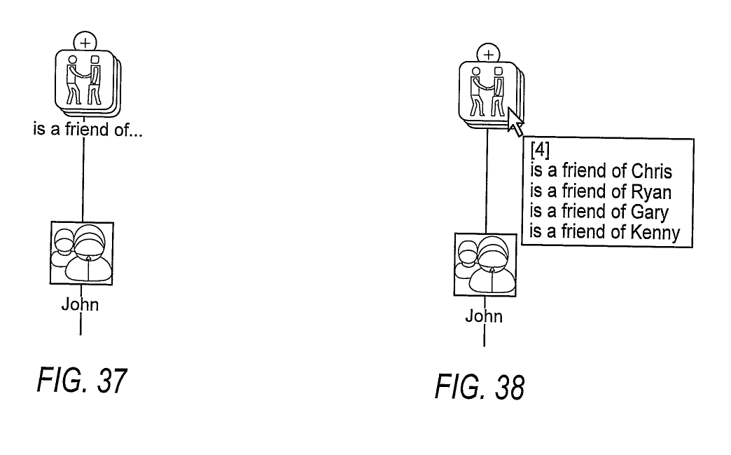

If a subject has many common relationships to multiple objects, one can aggregate them into a single aggregated predicate icon. For example, FIG. 36 represents four “is a friend of” statements: “John is a friend of Chris”, “John is a friend of Ryan”, “John is a friend of Gary” and “John is a friend of Kenny”. If the user happens to know a hundred people, this could easily clutter the graph, making it difficult to view and understand. If the user double-clicks with the mouse button any of the “knows” predicate icons, it will collapse into a single aggregated predicate icon as shown in FIG. 37. This is a compact representation of multiple predicates. The aggregated predicate icon looks similar to the individual predicate icons, but is larger, has a “stacked pages” appearance, and has an expand control on the top. Either clicking on the expand control or double-clicking on the aggregated predicate icon will expand it to the original four individual relationships. When the mouse cursor is hovered over the aggregated predicate icon, it will display details of the aggregated predicates, including the number of aggregated predicates, and the individual predicate-object statements as shown in FIG. 38.

### Social Net—Sharing Visual RDF

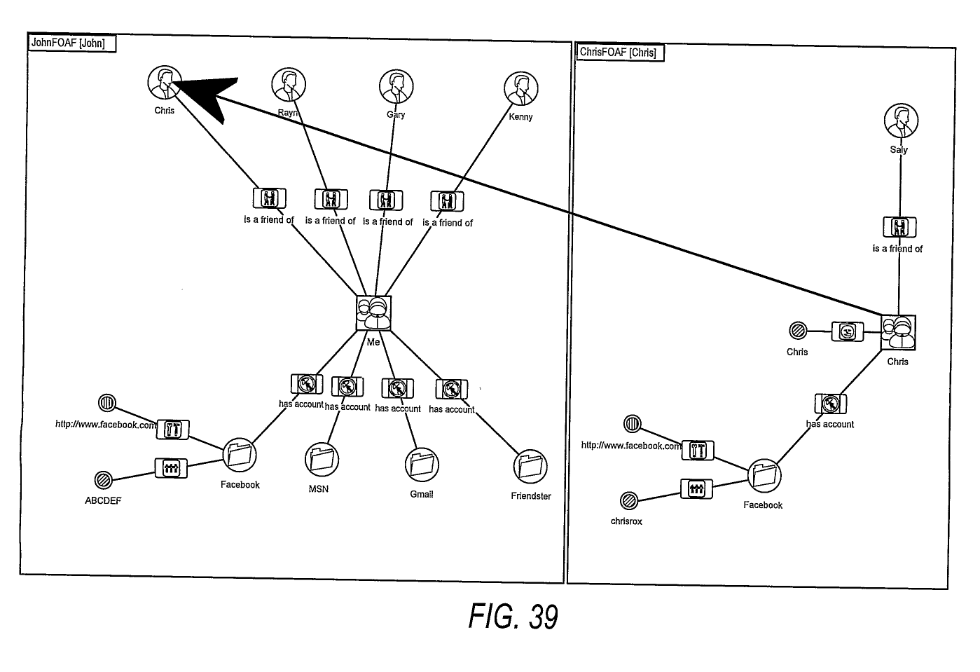

A user custom Icon Library, Ontology Libraries and Visual RDF Graphs may be shared with any other Visual RDF user. These may be exported as XML-based RDF files to be distributed via e-mail, etc. But most likely, they would be added to the libraries of other users. For example, if user A has created a new Lager Beer ontology, and through the Visual RDF application shares it with user B, then the Lager Beer ontology will now be available in his Ontology Library. Any dependent icons will also be added to user B Icon Library. If user John has a Visual RDF graph that user Chris has shared with him, he can open Chris graph in a second graph pane as shown in FIG. 39.

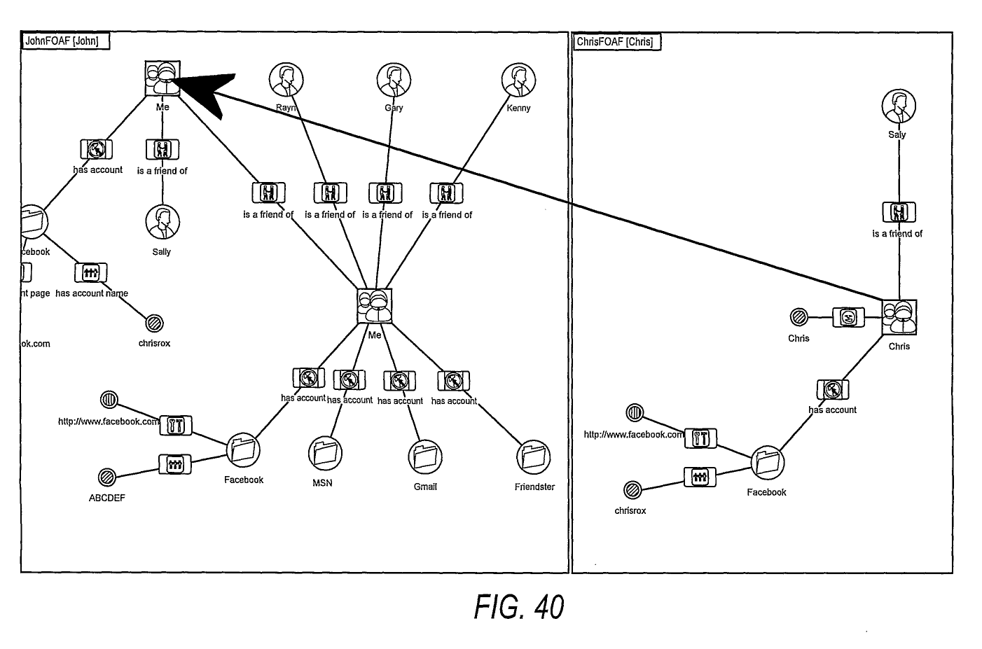

If the user then clicks and drags the “Chris” Person from Chris' graph onto the “Chris” Person in John's graph, the resulting graph will look like that shown in FIG. 40.

As in the paragraph above, if user Chris has shared his graph with user John, the Visual RDF application may notice that both graphs have the “Chris” Person. Visual RDF will then ask if the user would like to automatically merge Chris' graph into John's graph. If John agrees, then the Visual RDF application will extend John's graph with Chris' graph, and the result would be just as above.

### Visual RDF Queries

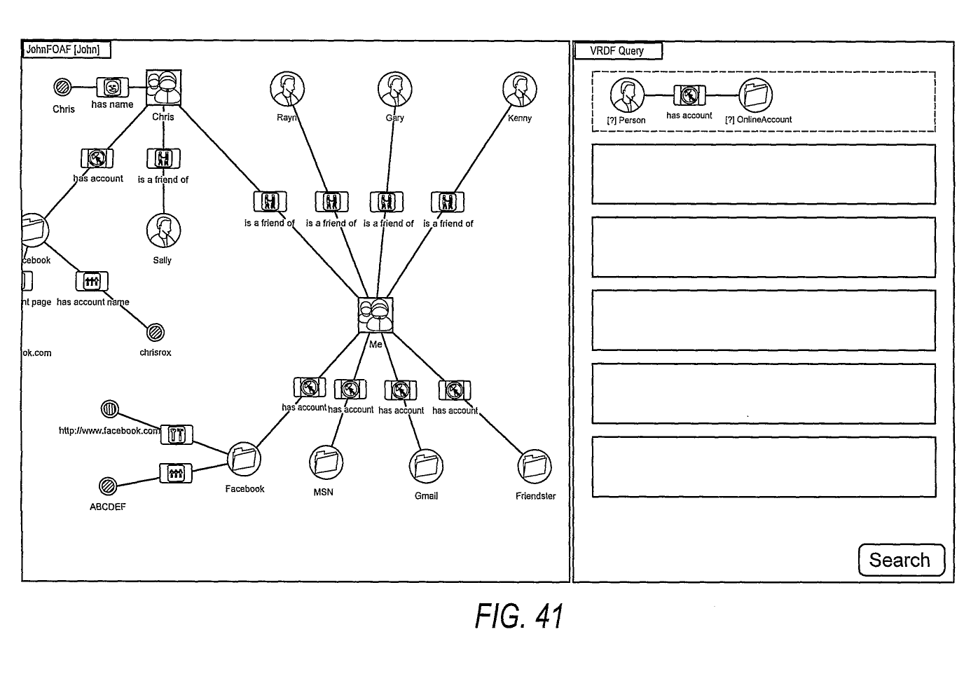

Visual RDF Queries are a visual abstraction of returning a graphical query result based on a user defined query. The query model is based on SPARQL, but other RDF query languages can be used as well. In the following example, the user brings up the Visual RDF Query panel as shown in FIG. 41. the user then drags a “has account” predicate from the FOAF Library into an empty query statement slot. The Visual RDF application interprets this as a query statement, that in plain English asks: “What persons have an online account?” The labels for both the subject and object of the visual query statement are prepended with “[?]” to indicate that one is looking for any Persons that has any online account.

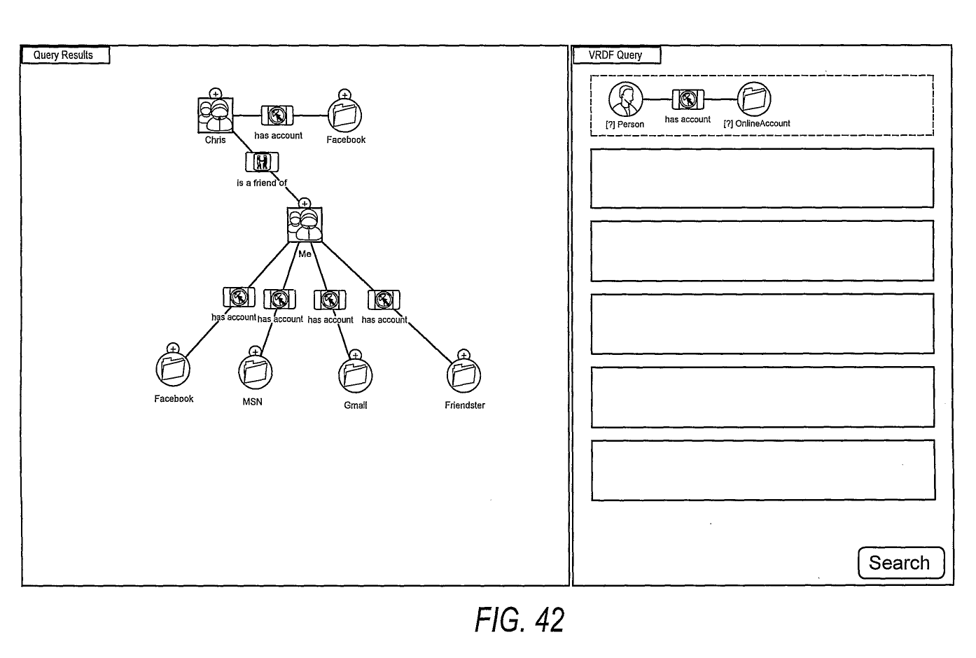

The user then clicks the Search button to view a visual representation of the query results in the main graph area as shown in FIG. 42. In this query result, there are actually five matching queries:

i) Chris has account Facebook

ii) Me has account Facebook

iii) Me has account MSN

iv) Me has account Gmail

v) Me has account Friendster.

In textual query language such as SPARQL, five triples would be returned as above, but in the Visual RDF graph, four “has account” predicates are associated with the “Me” person, and one “has account” predicate is associated with the “Chris” person. The form of the original graph is also preserved, with relationships that are not part of the query hidden from view. When the “+” expand control is clicked on the nodes of the graph, it can be expanded to the full graph.

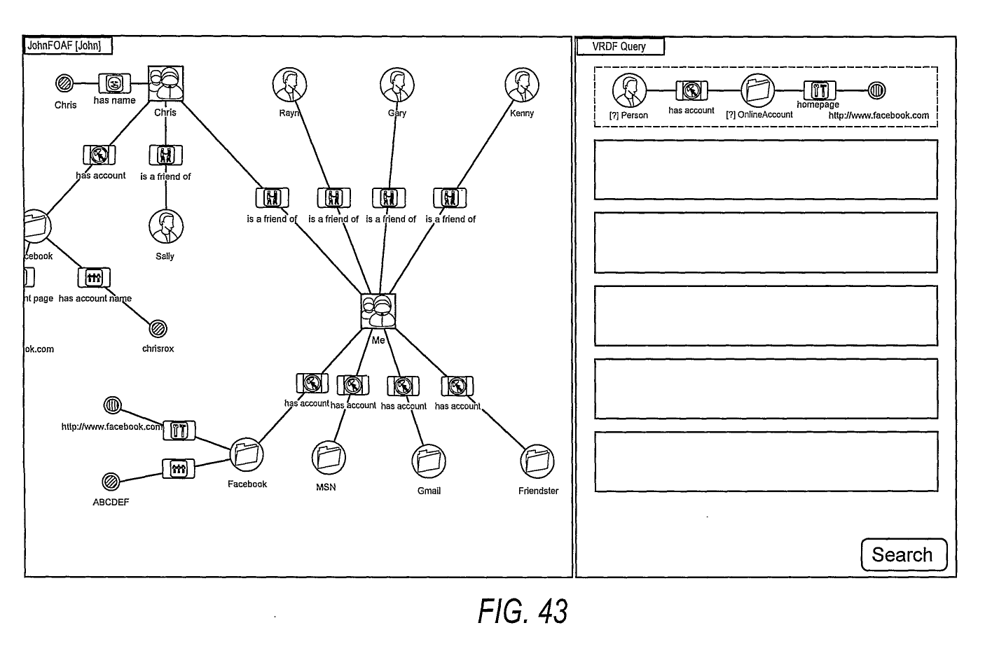

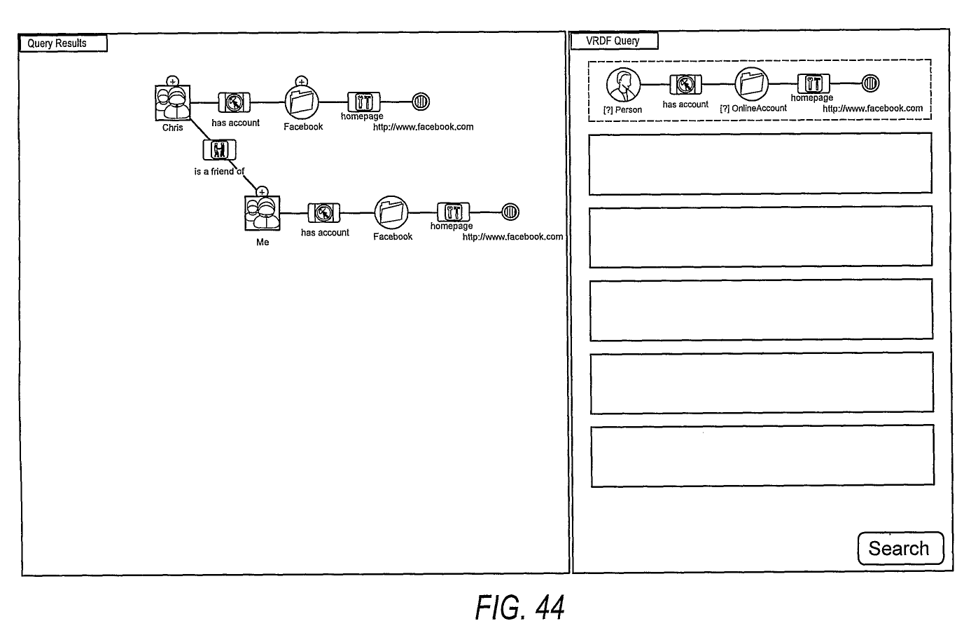

In the example, shown in FIG. 43, the previous query is built upon. The “homepage” predicate is dragged from the FOAF Library onto the existing query. The user then clicks on the literal object of the “homepage” predicate, and types in ttp://www.facebook.com The Visual RDF application interprets this as a query statement, that in plain English asks: “What persons have an online account with a homepage of http://www.facebook.com?” The user then clicks the Search button to display the result of this query as shown in FIG. 44.

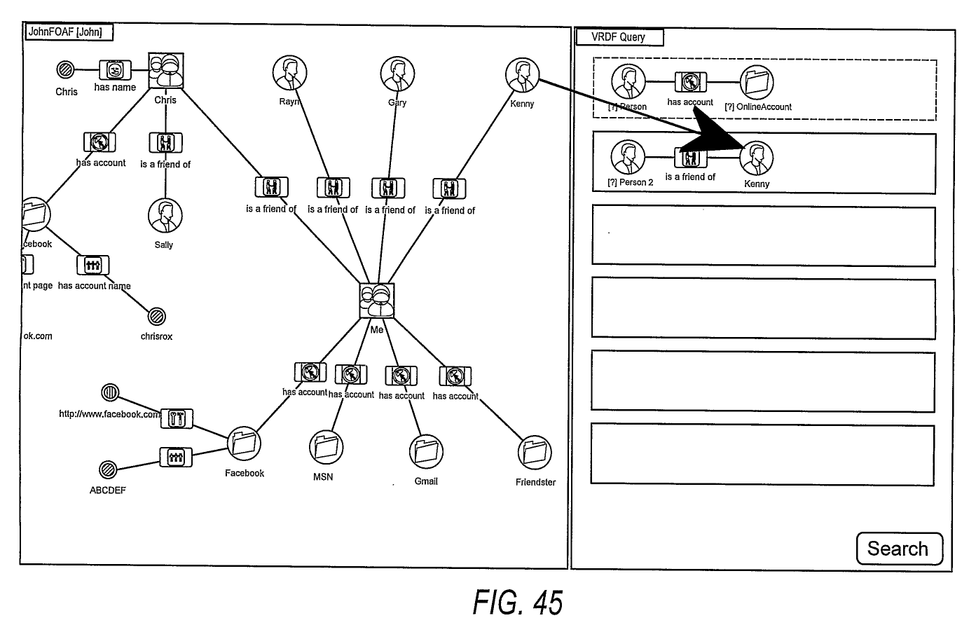

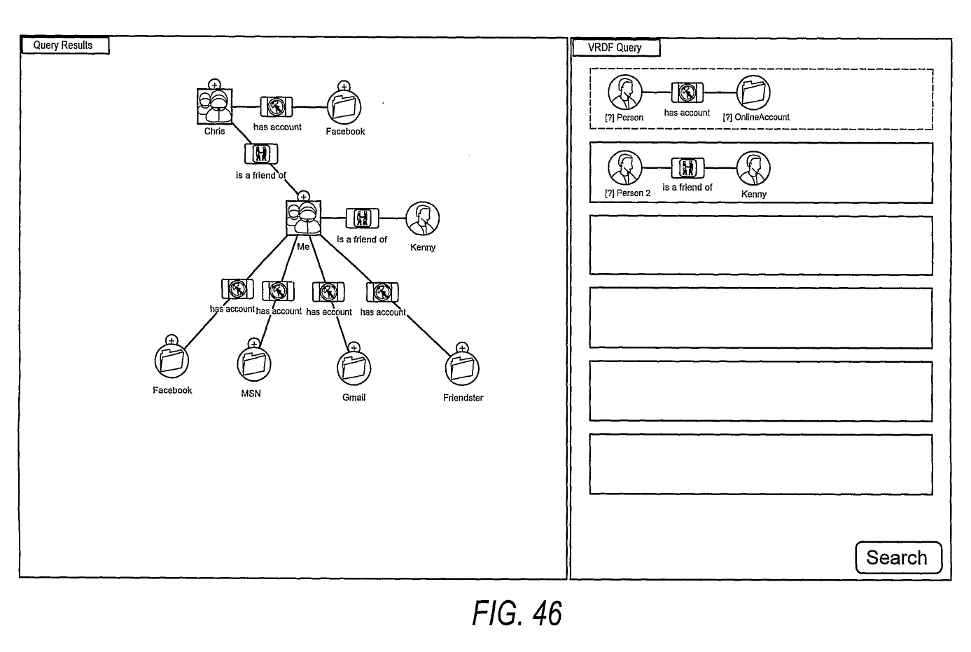

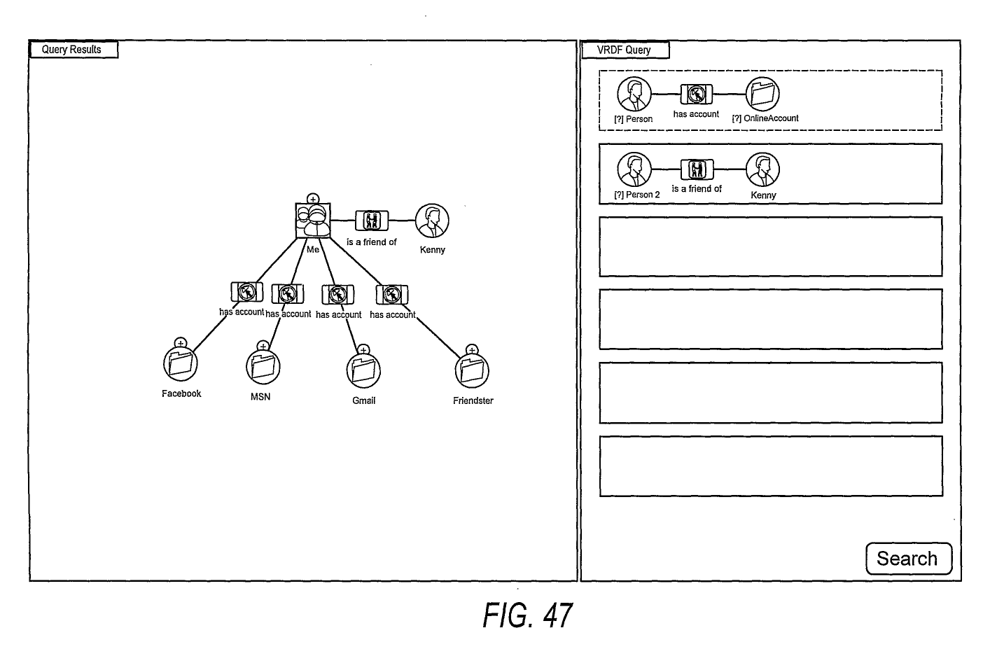

In the example shown in FIG. 45, there are two query statements. Firstly, a “has account” predicate is dragged into the first query slot, then an “is a friend of” predicate is dragged into the second query slot. For the second query slot, we want to find those Persons who are a friend of the “Kenny Person”, so we drag the “Kenny” Person from the main graph area, onto the object of the “is a friend of” predicate. In plain English, the query asks: “What persons have an online account; and what persons are a friend of Kenny?” The result of this query is shown in FIG. 46. One subtlety of the last query, is that five result statements match the first query statement, and one result statement matches the second query statement. If one want to modify the question by asking “What persons both have an online account and are a friend of Kenny?” then one would drag the “[?] Person” subject onto the “[?] Person 2” subject. The “[?] Person” subject is now the same subject for both query statements. The resulting query result is shown in FIG. 47.

Additional visual information can be provided in the graphs shown above by including variations in edge styles as well as visual identifier overlays. Predicate Qualifiers add further context to Predicates. For example, in the case of the Predicates “Likes” and “Is a Friend of”, and Predicate Qualifiers: “Does not”, “Is not” (Negation), “Very”, “Somewhat”, “Slightly” (Intensifiers) and “Now”, the following Qualified Predicates are formed: Does not like; Likes somewhat; Is a Friend Of; Is Not a Friend Of; Is a Good Friend Of. etc. In addition to solid edges connecting Subjects and Object nodes of a graph, other Edge Styles may be used to represent Predicate Qualifiers. Edge Styles can consists of variations of the following:
Thickness (thin, medium, thick, etc.)
Color (black, red, green, blue, etc.)
Dash Style (solid, dotted, dashed, double, etc.)

The following are some examples of using particular Edge Style to represent Predicate Qualifiers:
Intensity of the predicate: Thick=Very much, Medium=somewhat, Thin=slightly.
Intensity of the predicate: Solid=Very much, Dashed=somewhat, Dotted=slightly.
Intensity of the predicate: Black=Very much, Dark Gray=somewhat, Light Gray=slightly.
Negation of the predicate. Black=positive, Red=negation.
Bi-Directionality of the predicate: Solid=Bob knows Frank, Double-solid=Bob knows Frank and Frank knows Bob.

Similarly Predicate Visual Identifiers may be overlaid with Visual Identifier Overlays that qualify the predicate. For example:
Red slash=Negation (A is not a friend of B)
Completely Filled inset border=Intensity (A is a good friend of B)
Partially Filled inset border=Intensity (A is a somewhat a friend of B)

Certain literal Object Visual Identifiers may be overlaid with Visual Identifier Overlays that represents the literal in a visual manner. For example:
Clock displays the time. (“A has a meeting at 12:30 pm” can be displayed by linking A's icon by a “has a meeting” predicate icon to a clock icon overlaid with 12:30 pm).
Pie chart represents a percentage (“A's efficiency is 95%” can be displayed by linking A's icon by a “has an efficiency” predicate icon to a pie chart icon overlaid with 95%).

As will be apparent to those skilled in the art in the light of the foregoing disclosure, many alterations and modifications are possible in the practice of this invention without departing from the spirit or scope thereof. Accordingly, the scope of the invention is to be construed in accordance with the substance of the invention described above.

```
TABLE 1
Condensed FOAF Ontology
<!-- Definition 1: -->
  <rdfs:Class rdf:about=“http://xmlns.com/foaf/0.1/Person” rdfs:label=“Person”
rdfs:comment=“A person.” vs:term_status=“stable”>
    <rdf:type rdf:resource=“http://www.w3.org/2002/07/owl#Class”/>
    <rdfs:isDefinedBy rdf:resource=“http://xmlns.com/foaf/0.1/”/>
  </rdfs:Class>
<!-- Definition 2: -->
  <rdf:Property rdf:about=“http://xmlns.com/foaf/0.1/mbox” vs:term_status=“stable”
rdfs:label=“personal mailbox” rdfs:comment=“A
personal mailbox, ie. an Internet mailbox associated with exactly one owner, the first
owner of this mailbox. This is a ‘static inverse functional property’, in that there
is (across time and change) at most one individual that ever has any particular value
for foaf:mbox.”>
    <rdf:type rdf:resource=“http://www.w3.org/2002/07/owl#InverseFunctionalProperty”/>
    <rdf:type rdf:resource=“http://www.w3.org/2002/07/owl#ObjectProperty”/>
    <rdfs:domain rdf:resource=“http://xmlns.com/foaf/0.1/Agent”/>
    <rdfs:range rdf:resource=“http://www.w3.org/2002/07/owl#Thing”/>
    <rdfs:isDefinedBy rdf:resource=“http://xmlns.com/foaf/0.1/”/>
  </rdf:Property>
<!-- Definition 3: -->
  <rdf:Property rdf:about=“http://xmlns.com/foaf/0.1/name” vs:term_status=“testing”
rdfs:label=“name” rdfs:comment=“A name for some thing.”>
    <rdf:type rdf:resource=“http://www.w3.org/2002/07/owl#DatatypeProperty”/>
    <rdfs:domain rdf:resource=“http://www.w3.org/2002/07/owl#Thing”/>
    <rdfs:range rdf:resource=“http://www.w3.org/2000/01/rdf-schema#Literal”/>
    <rdfs:isDefinedBy rdf:resource=“http://xmlns.com/foaf/0.1/”/>
    <rdfs:subPropertyOf rdf:resource=“http://www.w3.org/2000/01/rdf-schema#label”/>
  </rdf:Property>
<!-- Definition 4: -->
  <rdf:Property rdf:about=“http://xmlns.com/foaf/0.1/knows” vs:term_status=“testing”
rdfs:label=“knows” rdfs:comment=“A person known by this person (indicating some level
of reciprocated interaction between the parties).”>
    <rdf:type rdf:resource=“http://www.w3.org/2002/07/owl#ObjectProperty”/>
    <rdfs:domain rdf:resource=“http://xmlns.com/foaf/0.1/Person”/>
    <rdfs:range rdf:resource=“http://xmlns.com/foaf/0.1/Person”/>
    <rdfs:isDefinedBy rdf:resource=“http://xmlns.com/foaf/0.1/”/>
  </rdf:Property>
<!-- Definition 5: -->
  <rdfs:Class rdf:about=“http://xmlns.com/foaf/0.1/OnlineAccount”
vs:term_status=“unstable” rdfs:label=“Online Account” rdfs:comment=“An online
account.”>
    <rdf:type rdf:resource=“http://www.w3.org/2002/07/owl#Class”/>
    <rdfs:isDefinedBy rdf:resource=“http://xmlns.com/foaf/0.1/”/>
    <rdfs:subClassOf rdf:resource=“http://www.w3.org/2002/07/owl#Thing”/>
  </rdfs:Class>
<!-- Definition 6: -->
  <rdf:Property rdf:about=“http://xmlns.com/foaf/0.1/holdsAccount”
vs:term_status=“unstable” rdfs:label=“holds account” rdfs:comment=“Indicates an
account held by this agent.”>
    <rdf:type rdf:resource=“http://www.w3.org/2002/07/owl#ObjectProperty”/>
    <rdfs:domain rdf:resource=“http://xmlns.com/foaf/0.1/Agent”/>
    <rdfs:range rdf:resource=“http://xmlns.com/foaf/0.1/OnlineAccount”/>
    <rdfs:isDefinedBy rdf:resource=“http://xmlns.com/foaf/0.1/”/>
  </rdf:Property>
<!-- Definition 7: -->
  <rdf:Property rdf:about=“http://xmlns.com/foaf/0.1/accountServiceHomepage”
vs:term_status=“unstable” rdfs:label=“account service homepage”
rdfs:comment=“Indicates a homepage of the service provide for this online account.”>
    <rdf:type rdf:resource=“http://www.w3.org/2002/07/owl#ObjectProperty”/>
    <rdfs:domain rdf:resource=“http://xmlns.com/foaf/0.1/OnlineAccount”/>
    <rdfs:range rdf:resource=“http://xmlns.com/foaf/0.1/Document”/>
    <rdfs:isDefinedBy rdf:resource=“http://xmlns.com/foaf/0.1/”/>
  </rdf:Property>
<!-- Definition 8: -->
  <rdf:Property rdf:about=“http://xmlns.com/foaf/0.1/accountName”
vs:term_status=“unstable” rdfs:label=“account name” rdfs:comment=“Indicates the name
(identifier) associated with this online account.”>
    <rdf:type rdf:resource=“http://www.w3.org/2002/07/owl#DatatypeProperty”/>
    <rdfs:domain rdf:resource=“http://xmlns.com/foaf/0.1/OnlineAccount”/>
    <rdfs:range rdf:resource=“http://www.w3.org/2000/01/rdf-schema#Literal”/>
    <rdfs:isDefinedBy rdf:resource=“http://xmlns.com/foaf/0.1/”/>
  </rdf:Property>
Exported FOAF RDF
<?xml version=“1.0” encoding=“ISO-8859-1”?>
<!DOCTYPE rdf:RDF [
      <!ENTITY rdf “http://www.w3.org/1999/02/22-rdf-syntax-ns#”>
      <!ENTITY rdfs “http://www.w3.org/2000/01/rdf-schema#”>
      <!ENTITY foaf “http://xmlns.com/foaf/0.1/”>
      <!ENTITY wil “http://whatilike.org/ontology#”>
]>
<rdf:RDF xmlns:rdf=“http://www.w3.org/1999/02/22-rdf-syntax-ns#”
xmlns:rdfs=“http://www.w3.org/2000/01/rdf-schema#”
xmlns:foaf=“http://xmlns.com/foaf/0.1/”
xmlns:geo=“http://www.w3.org/2003/01/geo/wgs84_pos#”
xmlns:sn=“http://www.dcs.shef.ac.uk/~mrowe/ontologies/social-networks.owl#”
xmlns:admin=“http://webns.net/mvcb/”>
      <foaf:PersonalProfileDocument rdf:about=“”>
            <foaf:maker rdf:resource=“#John”/>
            <foaf:primaryTopic rdf:resource=“#John”/>
            <admin:generatorAgent
rdf:resource=“http://vrdf.aftercad.com/rdfgenerator.html”/>
            <admin:errorReportsTo rdf:resource=“mailto:admin@vrdf.aftercad.com”/>
      </foaf:PersonalProfileDocument>
      <foaf:Person rdf:ID=“John”>
            <foaf:name>John Smith</foaf:name>
            <foaf:holdsAccount>
                  <foaf:OnlineAccount>
                        <foaf:accountServiceHomepage
rdf:resource=“http://www.facebook.com/”/>
                        <foaf:accountName>ABCDEF</foaf:accountName>
                  </foaf:OnlineAccount>
            </foaf:holdsAccount>
            <foaf:holdsAccount>
                  <foaf:OnlineAccount rdf:ID=“Friendster”>
                  </foaf:OnlineAccount>
            </foaf:holdsAccount>
            <foaf:holdsAccount>
                  <foaf:OnlineAccount rdf:ID=“Gmail”>
                  </foaf:OnlineAccount>
            </foaf:holdsAccount>
            <foaf:holdsAccount>
                  <foaf:OnlineAccount rdf:ID=“MSN”>
                  </foaf:OnlineAccount>
            </foaf:holdsAccount>
            <foaf:knows>
                  <foaf:Person rdf:ID=“Gary”>
                  </foaf:Person>
            </foaf:knows>
            <foaf:knows>
                  <foaf:Person rdf:ID=“Ryan”>
                  </foaf:Person>
            </foaf:knows>
            <foaf:knows>
                  <foaf:Person rdf:ID=“Chris”>
                  </foaf:Person>
            </foaf:knows>
            <foaf:knows>
                  <foaf:Person rdf:ID=“Kenny”>
                  </foaf:Person>
            </foaf:knows>
      </foaf:Person>
</rdf:RDF>
```

What is claimed is:

1. A computer-implemented method of creating a semantic ontology using non-verbal symbols, comprising:
a) creating a set of non-verbal symbols;
b) associating each said non-verbal symbol with a predicate, wherein each predicate has an associated RDF term;
c) creating a plurality of RDF statements by selecting a plurality of pairs of subjects and objects, each said subject and object having an associated RDF term, and linking each said pair with one of said non-verbal symbols identifying a predicate;
d) saving said plurality of RDF statements in a computer memory.

2. The method of claim 1 comprising the further steps of:
e) linking a plurality of said RDF statements having common subjects and objects to form a linked set of RDF statements;
d) saving said linked set of RDF statements in a computer memory.

3. The method of claim 1 wherein said non-verbal symbols are visual symbols.

4. The method of claim 1 wherein said non-verbal symbols are visual icons.

5. The method of claim 2 wherein said network comprises a visual graph wherein subjects and objects are nodes and predicates are arcs.

6. The method of claim 1 wherein each said subject and object is associated with a non-verbal symbol having an associated RDF term.

7. The method of claim 6 wherein said set of non-verbal symbols is created by selecting a previously created library of objects and predicates, each associated with an RDF term, and associating a non-verbal symbol with an object or predicate.

8. The method of claim 1 wherein said RDF terms are XML statements.

9. The method of claim 1 wherein said stored plurality of RDF statements is shared among two or more users.

10. The method of claim 1 wherein said non-verbal symbol associated with a predicate by a first user is mapped onto the non-verbal symbol associated with the same predicate by a second user to permit sharing of ontologies between said first and second user.

11. The method of claim 1 comprising the further step of searching said plurality of RDF statements by using said non-verbal symbols to create semantic queries using query language.

12. The method of claim 11 wherein said query language is SPARQL.

13. A computer-implemented system for creating a semantic ontology using non-verbal symbols comprising:
a) computer-implemented means for creating a set of non-verbal symbols;
b) computer-implemented means for associating each said non-verbal symbol with a predicate, wherein each predicate has an associated RDF term;
c) computer-implemented means for creating a plurality of RDF statements by selecting a plurality of pairs of subjects and objects, each said subject and object having an associated RDF term, and linking each said pair with one of said non-verbal symbols identifying a predicate;
d) computer-implemented means for saving said plurality of RDF statements in a computer memory.

14. The system of claim 13 comprising the further steps of:
e) computer-implemented means for linking a plurality of said RDF statements having common subjects and objects to form a linked set of RDF statements;
d) computer-implemented means for saving said linked set of RDF statements in a computer memory.

15. The system of claim 13 wherein said non-verbal symbols are visual symbols.

16. The system of claim 13 wherein said non-verbal symbols are visual icons.

17. The system of claim 14 wherein said linked set comprises a visual graph wherein subjects and objects are nodes and predicates are arcs.

18. The system of claim 13 wherein each said subject and object is associated with a non-verbal symbol having an associated RDF term.

19. The system of claim 18 wherein said set of non-verbal symbols is created by selecting a previously created library of objects and predicates, each associated with an RDF term, and associating a non-verbal symbol with an object or predicate.

20. The system of claim 13 wherein said RDF terms are XML statements.

21. The system of claim 13 wherein said stored plurality of RDF statements is shared among two or more users.

22. The system of claim 13 wherein said non-verbal symbol associated with a predicate by a first user is mapped onto the non-verbal symbol associated with the same predicate by a second user to permit sharing of ontologies between said first and second user.

23. The system of claim 13 further comprising computer-implemented means for searching said plurality of RDF statements by using said non-verbal symbols to create semantic queries using query language.

24. The method of claim 23 wherein said query language is SPARQL.
